(19) United States
(12) Patent Application Publication
(10) Pub. No.: US 2015/0268867 A1
(43) Pub. Date: Sep. 24, 2015

(54) STORAGE CONTROLLING APPARATUS, COMPUTER-READABLE RECORDING MEDIUM HAVING STORED THEREIN CONTROL PROGRAM, AND CONTROLLING METHOD

(71) Applicant: FUJITSU LIMITED, Kawasaki-shi (JP)

(72) Inventors: Kazuichi OE, Yokohama (JP); Satoshi IWATA, Yokohama (JP); Motoyuki KAWABA, Kawasaki (JP)

(21) Appl. No.: 14/628,672

(22) Filed: Feb. 23, 2015

(30) Foreign Application Priority Data
Mar. 19, 2014 (JP) 2014-056799

(51) Int. Cl. G06F 3/06

(52) U.S. Cl. CPC G06F 3/0608; G06F 3/0688; G06F 3/065; G06F 3/0655; G06F 3/0647; G06F 3/0685

(57) ABSTRACT

A storage controlling apparatus includes a processor that monitors a response performance to an inputted request regarding a plurality of unit regions obtained by dividing a storage region of the first storage apparatus in a predetermined size, divides, in a moving process for moving data stored in a unit region, which is a movement target, of the first storage apparatus to a second storage apparatus having a performance different from that of the first storage apparatus, the unit region of the movement target into a plurality of divisional regions by a predetermined division number and moves the data to the second storage apparatus in a unit of the divisional region, and changes the predetermined division number based on a first response performance during execution of the monitored moving process.

### CROSS-REFERENCE TO RELATED APPLICATION

This application is based upon and claims the benefit of priority of the prior Japanese Patent Application No. 2014-056799, filed on Mar. 19, 2014, the entire contents of which are incorporated herein by reference.

### FIELD

The present technology relates to a storage controlling apparatus, a computer-readable recording medium having stored therein a controlling program, and a controlling method.

### BACKGROUND

A hierarchical storage system in which a plurality of recording media (storage apparatus) are combined is sometimes used as a storage system for storing data. The hierarchical storage system includes, for example, an Solid State Drive (SSD) that can implement high-speed access and is comparatively small in capacity and high in price and an Hard Disk Drive (HDD) that is great in capacity and low in price but is comparatively low in speed.

In the hierarchical storage system, a region to which the access frequency is low is disposed in the HDD and another region to which the access frequency is high is disposed in the SSD so that a use efficiency of the SSD can be enhanced and the performance of the entire system can be enhanced. In particular, in order to enhance the performance of the hierarchical storage system, it is desirable to dispose a region to which the access frequency is high in the SSD efficiently.

As a technique for efficiently disposing a region to which the access frequency is high in the SSD, for example, a method for disposing a region to which the access frequency is high in the SSD efficiently in a unit of one day in response to the access frequency in the preceding day is available. In particular, the hierarchical storage system totalizes the access frequency by 24 hours within a midnight time zone within which the access frequency by a user is low and disposes regions in the SSD in descending order of the access frequency. This method is sufficient to a workload in which access concentration to a substantially same region occurs every day.

However, in a workload in which access concentration (load) moves within a comparatively short time period from approximately several minutes to several ten minutes, in most cases, the movement is difficult to follow up by totalization of the access frequency in a unit of one day. It is to be noted that the workload signifies an access distribution to the storage apparatus and varies in response to lapse of time and an offset position (region) of the storage apparatus. In order to cope with the workload in which a load moves within a short time period, it is preferable to grasp a region in which the access frequency increases on the real time basis and move the region to the SSD.

Further, also when data is to be moved from the HDD to the SSD, there is the possibility that an Input Output (IO) from the user to the data (hereinafter referred to as user IO) may occur. As a countermeasure for the user IO, for example, a technology is known in which a storage system transfers target data to a sharing memory or the like during movement of the data from a first volume to a second volume such that the data can be placed in a state in which access response can be performed (for example, refer to Patent Document 1). By the technology, the access performance to the target data during movement is secured.

Also a technology is known in which, when accessing from a data processing apparatus to a logical storage apparatus occurs, a storage controlling apparatus performs accessing to a re-disposition destination or the logical storage apparatus in response to whether the accessing position is a re-disposition completion region or a re-disposition incompletion region (for example, refer to Patent Document 2).

Also a technology is known in which a storage management apparatus divides a logical segment and a physical segment within an access target range into sub logical segments and sub physical segments (for example, refer to Patent Document 3). In the technology, by re-disposing target data in a unit of a sub segment by the storage management apparatus, a load to the storage apparatus can be dispersed and the access performance can be enhanced.

[Patent Document 1] Japanese Laid-Open Patent Publication No. 2008-299559

[Patent Document 2] Japanese Laid-Open Patent Publication No. 2003-271425

[Patent Document 3] International Publication Pamphlet No. 2008/126202

In the technique for transferring, during movement of data, target data to a temporary buffer to process a user IO, since a process such as sync (synchronization) occurs between the temporary buffer and the SSD that is a movement destination after completion of the movement, the movement time period increases.

While it is a possible idea as a method for moving data within the shortest time period to block a user IO to the data during movement of the data, if a user IO is blocked, then a response of the user IO degrades. On the other hand, if the region to be moved at once by the hierarchical storage system is reduced, then the degree of response degradation of the user IO can be decreased. However, the moving time period increases instead.

### SUMMARY

According to an aspect of the embodiment, a storage controlling apparatus includes a processor. The processor monitors a response performance to an inputted request regarding a plurality of unit regions obtained by dividing a storage region of the first storage apparatus in a predetermined size. Further, the processor performs processes described below in a moving process for moving data stored in a unit region, which is a movement target, of the first storage apparatus to a second storage apparatus having a performance different from that of the first storage apparatus. Here, the processor divides the unit region of the movement target into a plurality of divisional regions by a predetermined division number and moves the data to the second storage apparatus in a unit of the divisional region. Further, the processor changes the predetermined division number based on a first response performance during execution of the monitored moving process.

The object and advantages of the technology will be realized and attained by means of the elements and combinations particularly pointed out in the claims.

It is to be understood that both the foregoing general description and the following detailed description are exemplary and explanatory and are not restrictive of the technology, as claimed.

### BRIEF DESCRIPTION OF DRAWINGS

FIG. 1 is a view depicting an example of a technique for blocking a user IO appearing in a moving region during hierarchical movement;

FIG. 2 is a view depicting an example in which the moving region moves in a unit of a sub segment;

FIG. 3 is a view depicting an example of a relationship between a division number of sub segments and region moving time;

FIG. 4 is a view depicting an example of a relationship between a division number of sub segments and IO response time;

FIG. 5 is a view depicting an example of IO response time where the division number of sub segments is set to 256;

FIG. 6 is a view depicting an example of IO response time where the division number of sub segments is set to 2048;

FIG. 7 is a view depicting an example of a configuration of a hierarchical storage system according to an embodiment;

FIG. 8 is a view depicting an example of a database depicted in FIG. 7;

FIG. 9 is a view depicting an example of a hierarchy table depicted in FIG. 7

FIG. 10 is a flow chart illustrating an example of operation of a data collection process by a data collection unit;

FIG. 11 is a flow chart illustrating an example of operation of a movement decision process by a workload analysis unit;

FIG. 12 is a flow chart illustrating an example of operation of a movement instruction notification process by a movement instruction unit;

FIG. 13 is a flow chart illustrating an example of operation of a division number decision process by a division number decision unit;

FIG. 14 is a flow chart illustrating an example of operation of a transfer instruction notification process by a hierarchy driver;

FIG. 15 is a flow chart illustrating an example of operation of a transfer completion reception process by the hierarchy driver;

FIG. 16 is a flow chart illustrating an example of operation of a transfer instruction reception process by a division unit;

FIG. 17 is a flow chart illustrating an example of operation of a division number update process by the division unit;

FIG. 18 is a flow chart illustrating an example of operation of an IO reception process by an IO map unit;

FIG. 19 is a view depicting an example of a hardware configuration of a hierarchical storage controlling apparatus depicted in FIG. 7;

FIGS. 20 and 21 are views illustrating dynamic hierarchy control by the hierarchical storage controlling apparatus according to an example of application;

FIG. 22 is a view depicting an example of a configuration a hierarchical storage system according to the application example;

FIG. 23 is a flow chart illustrating an example of operation of a data collection process by a data collection unit according to the application example;

FIG. 24 is a view depicting an example of a database depicted in FIG. 22;

FIG. 25 is a flow chart illustrating an example of operation of a movement decision process by a workload analysis unit according to the application example;

FIG. 26 is a view depicting an example of a candidate table depicted in FIG. 22;

FIG. 27 is a view depicting an example of a management table depicted in FIG. 22; and

FIG. 28 is a flow chart illustrating an example of operation of a movement instruction notification process by a movement instruction unit according to the application example.

### DESCRIPTION OF EMBODIMENTS

In the following, an embodiment of the present technology is described with reference to the drawings.

### [1] Embodiment

[1-1] Example of Contrast

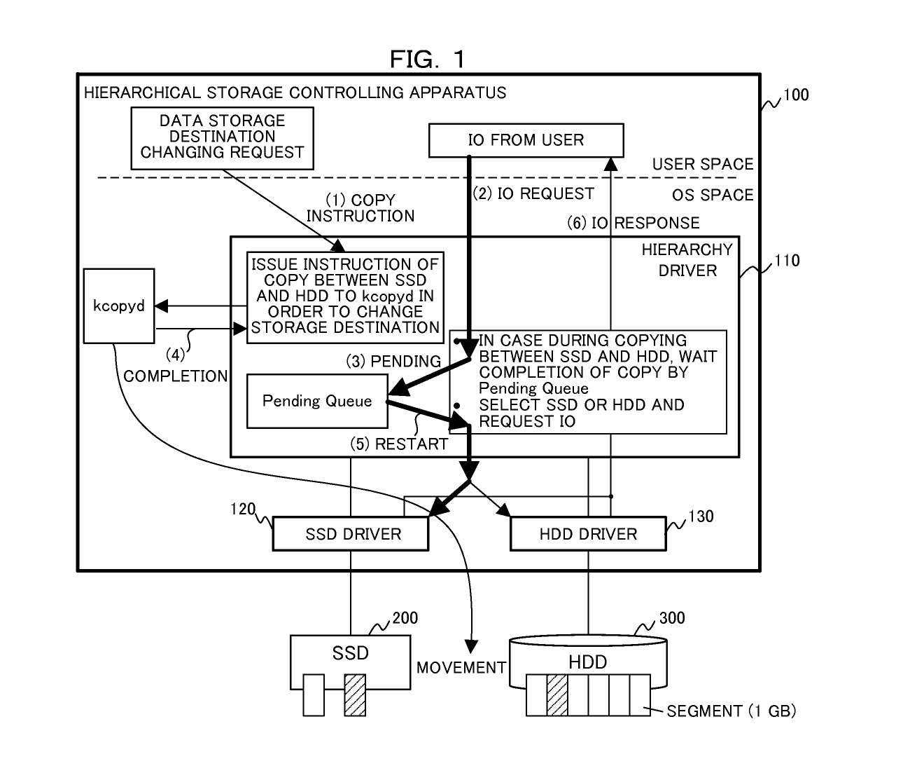

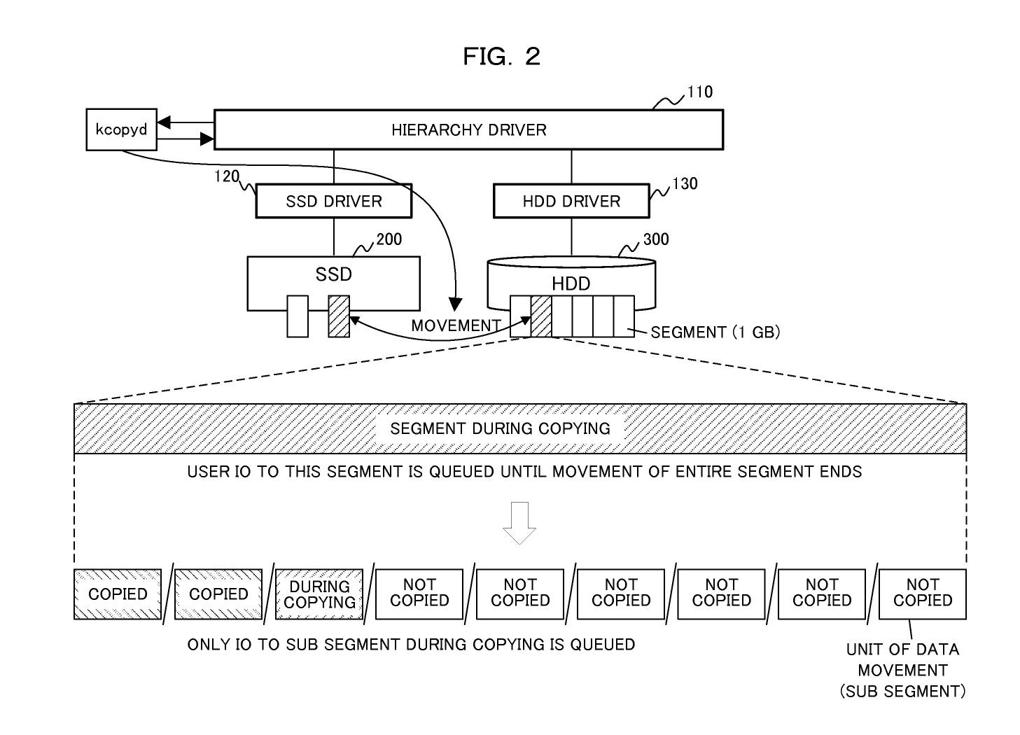

First, a comparative example depicted in FIGS. 1 and 2 is described. FIG. 1 is a view depicting an example of a technique for blocking a user IO appearing in a moving region during hierarchical movement, and FIG. 2 is a view depicting an example wherein a movement region is moved in a unit of a sub segment. It is to be noted that, in FIGS. 1 and 2, it is assumed that a hierarchical storage controlling apparatus 100 uses a function of a Linux (registered trademark) device-mapper. In this example, the device-mapper monitors a storage volume in a unit of a segment, and moves data of a segment to which a high load comes to be applied from an HDD 300 to an SSD 200 to process an IO to the high-load segment.

First, referring to FIG. 1, an application executed in a user space of the hierarchical storage controlling apparatus 100 issues a copy instruction as a request for changing a data storage destination (refer to reference character (1) of FIG. 1). When the copy instruction is received, in order to change the storage destination, a hierarchy driver 110 executed in an Operation System (OS) space issues an instruction for copying (movement) between the SSD 200 and the HDD 300 to a kcopyd that executes data copy between devices asynchronously. If an IO request is issued from the user during movement by the kcopyd (refer to reference character (2) of FIG. 1), then the hierarchy driver 110 stores the IO request into a pending queue such as a memory and performs waiting until the movement is completed (refer to reference character (3) of FIG. 1). It is to be noted that the device-mapper and the kcopyd are incorporated as computer programs.

If the movement is completed (refer to reference character (4) of FIG. 1), then the hierarchy driver 110 selects the SSD 200 or the HDD 300 as a movement destination of the data and issues the IO request pending in the pending queue through an SSD 120 or an HDD 130 (refer to reference character (5) of FIG. 1). Then, the SSD 200 or the HDD 300 of the movement destination that receives the IO request returns an IO response to the user (refer to reference character (6) of FIG. 1).

In the example depicted in FIG. 1, a time period within which the IO response is left pending in the pending queue looks as it is as degradation of the response to the user. For example, if it is assumed that the segment=1 GB (Byte), the throughput performance of the HDD 300=100 MB/sec and the throughput performance of the SSD 200=1000 MB/sec, then the movement time period is 1 [GB]/100 [MB/sec]=10 seconds. In particular, it is recognized that there is the possibility that the user IO may be kept waiting by 10 seconds at the longest. Even if the waiting is temporary, it is not allowed in most cases that, in the hierarchical storage system, the user IO waits by maximum 10 seconds.

On the other hand, in FIG. 2, a segment is divided into sub segments that are smaller units and the hierarchical storage controlling apparatus 100 performs region movement in a unit of a sub segment. Consequently, the waiting time period of the user IO can be suppressed to a movement time period of a sub segment that is shorter than a movement time period of the entire segment.

However, where the region movement is performed in a unit of a sub segment as depicted in FIG. 2, the entire movement cost increases rather than the movement cost upon region movement in a unit of a segment. This is because an overhead outside the movement time period increases by the division number of the sub segments.

Therefore, it is desired to complete segment movement within a time period as short as possible while the user IO pending time period upon segment movement is reduced as far as possible. As described above, it is a possible idea to divide a segment into sub segments and further increase the division number to decrease the pending time period of the user IO. However, the movement time period of the entire segment increases by a great amount.

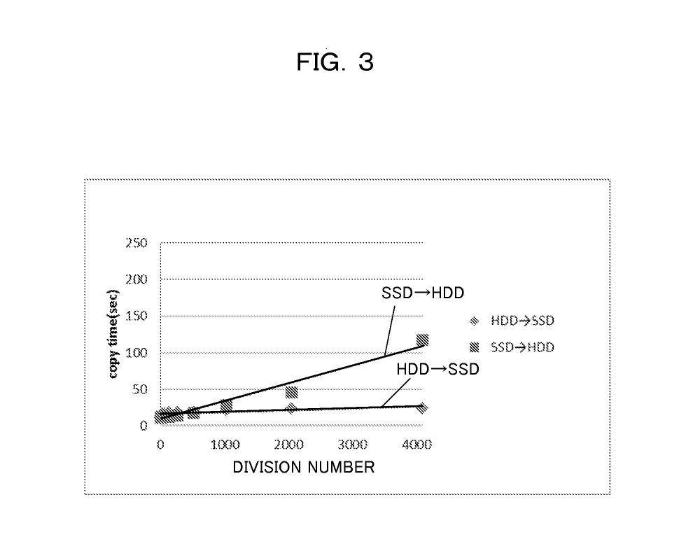

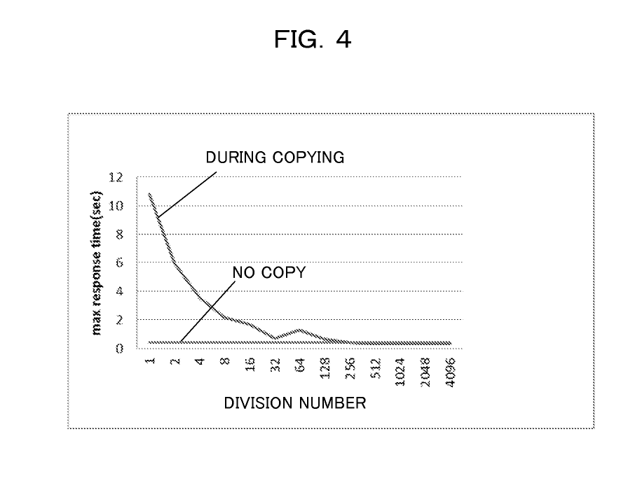

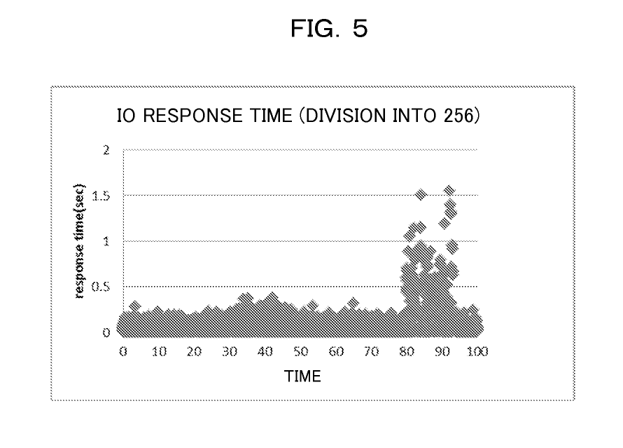

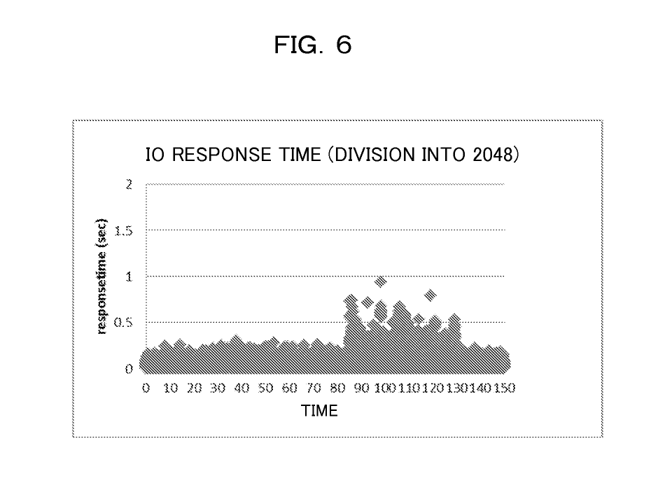

FIGS. 3 to 6 depict a result of evaluation in which it is evaluated by what degree the movement time period increases when the division number into sub segments is increased. FIG. 3 is a view depicting an example of a relationship between the division number sub segments and the region movement time and FIG. 4 is a view depicting an example of the relationship between the division number into sub segments and the IO response time. FIGS. 5 and 6 are views depicting an example of IO response time where the division number of sub segments is set to 256 and 2048, respectively. It is to be noted that FIGS. 3 to 6 depict results of evaluation in an environment where the segment=1 GB, the throughput performance of the HDD 300=100 MB/sec and the throughput performance of the SSD 200=1000 MB/sec.

For example, as depicted in FIG. 3, region movement from the SSD 200 to the HDD 300 is completed in approximately 10 seconds where the segment is not divided. However, it is recognized that, if the division number increases, then the region movement time increases to approximately 12 times (120 seconds) at the greatest.

On the other hand, as depicted in FIG. 4, as regards the response time to a user IO, the IO response time during copying is 10 seconds or more where the segment is not divided. However, the IO response time is shorter than 0.4 seconds in average where the division number is 256 or more. This is the response time equal to average response time where copying is not performed. However, even if the division number is 256, a case in which the response time exceeds one second may possibly occur partly as depicted in FIG. 5. Therefore, even if the division number is increased by some degrees, it is not always possible to completely hide the influence of the movement of the segment.

It is to be noted that, while, also with regard to a request to which the response time exceeds one second, the response time can be decreased by increasing the division number still more, the copying time increases as much. For example, if the division number is set to 2048 as depicted in FIG. 6, then a request to which the response time becomes one second or more does not occur anymore. However, the region movement time upon movement from the SSD 200 to the HDD 300 drastically increases from 14 seconds (256 divisions) to 45 seconds (2048 divisions) (refer to FIG. 3).

Where the response time of the user IO is decreased shorter than one second, while it is desired to set the division number to 2048 or more in the examples of FIGS. 5 and 6, where such short response time guarantee is not requested in the hierarchical storage system, the division number is sufficient if it is 256. In this manner, if the response time to a user IO to be guaranteed is determined in advance and a movement unit of a degree with which it does not exceed the response time is determined, then the movement time is suppressed.

It is to be noted that it can be supposed readily that the evaluation (experiment) result depicted in FIGS. 3 to 6 varies depending upon equipment (for example, the SSD 200, the HDD 300, a bus or the like) or a workload used in the hierarchical storage system. In the evaluation result, while the division number of 256 is an optimum value from FIG. 4, there is the possibility that, if a condition of used equipment or the like varies, then also the division number may be increased or decreased.

Incidentally, a relationship between the movement unit and an overhead applied to a user IO, namely, response degradation, varies depending upon equipment or a workload used in the hierarchical storage system. In particular, in a simple technique such as threshold value control, it is difficult to perform region movement in a movement unit optimum to the hierarchical storage system in response to a variation of a performance of equipment, a workload or the like

[1-2] Description of Hierarchical Storage System

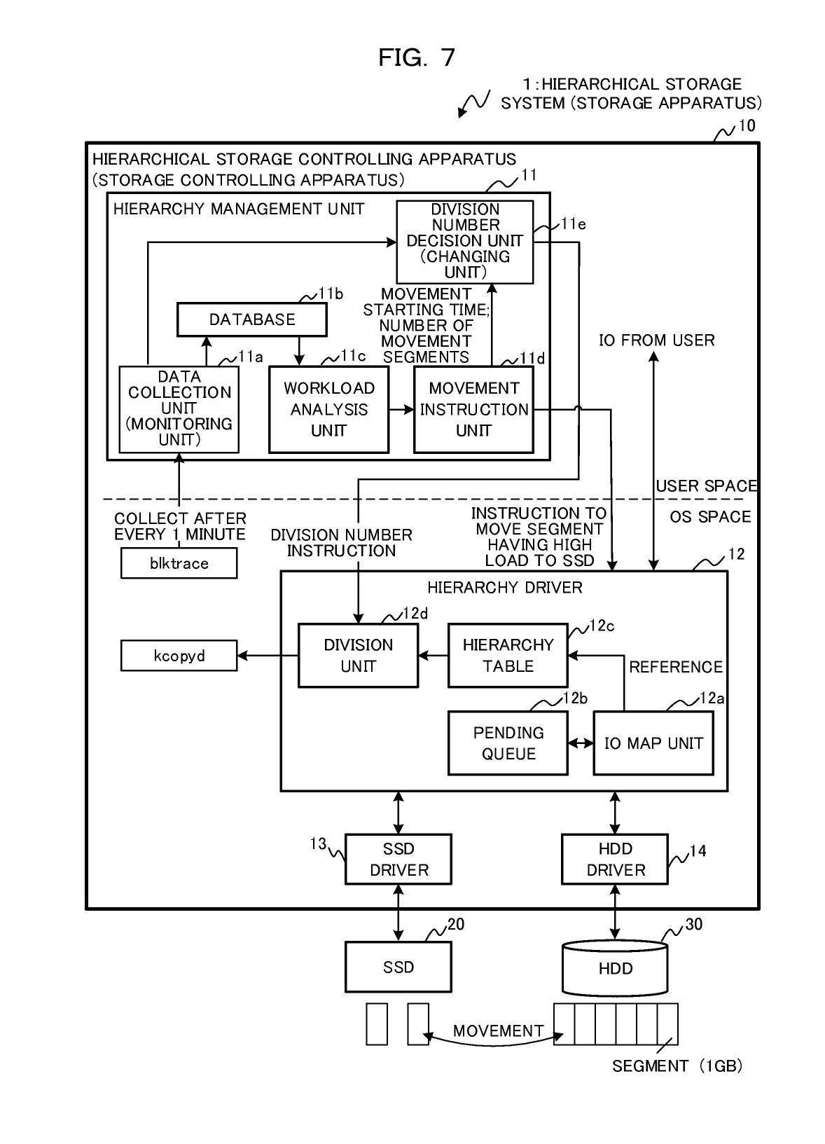

In view of the points described above, a hierarchical storage system 1 (refer to FIG. 7) according to the present embodiment can dynamically change a movement unit in response to variation of a response of a user IO by monitoring an average response of the user IO as hereinafter described in detail. Consequently, the hierarchical storage system 1 can autonomously minimize the division number while a response equal to an immediately preceding average response is maintained. In particular, degradation of the response performance to an inputted request can be suppressed while the processing time to be used for data movement from a first storage apparatus to a second storage apparatus is decreased.

FIG. 7 is a view depicting an example of a configuration of the hierarchical storage system 1 according to the embodiment. As depicted in FIG. 7, the hierarchical storage system (storage apparatus) 1 includes a hierarchical storage controlling apparatus 10, an SSD 20 and an HDD 30.

The hierarchical storage controlling apparatus 10 can perform various kinds of accessing to the SSD 20 and the HDD 30 in response to a user IO from an inputting apparatus not depicted or from a host apparatus through a network. For example, the hierarchical storage controlling apparatus 10 can perform accessing such as reading and writing to the SSD 20 and the HDD 30. As the hierarchical storage controlling apparatus 10, an information processing apparatus such as a Personal Computer (PC), a server or a controller module (CM) is available.

Further, the hierarchical storage controlling apparatus 10 according to the present embodiment can perform dynamic hierarchy control for disposing, in response to an access frequency of the user IO, a region in which the access frequency is low in the HDD 30 but disposing a region in which the access frequency is high in the SSD 20.

The HDD 30 is an example of a storage apparatus for storing various kinds of data or programs therein, and the SSD 20 is an example of a storage apparatus having a performance (for example, higher speed) different from that of the HDD 30. In the present embodiment, while a magnetic disk apparatus such as the HDD 30 and a semiconductor drive apparatus such as the SSD 20 are taken as an example of the storage apparatus (hereinafter referred to sometimes as first and second storage apparatus for the convenience of description) different from each other, respectively, the components are not limited to them. As the first and second storage apparatus, various storage apparatus having performances different from each other (for example, different in speed in reading/writing) may be used.

The SSD 20 and the HDD 30 configure a storage volume in the hierarchical storage system 1. The SSD 20 and the HDD 30 individually include a storage region capable of storing data of segments (unit regions) on the storage volume therein. The segment is a minimum unit of hierarchical movement by the hierarchical storage controlling apparatus 10 and one segment is 1 GB in FIG. 7. The hierarchical storage controlling apparatus 10 controls region movement between the SSD 20 and the HDD 30 in a unit of a segment.

It is to be noted that, while the hierarchical storage system 1 includes one SSD 20 and one HDD 30 in FIG. 7, the configuration of the same is not limited to this and the hierarchical storage system 1 may include a plurality of SSDs 20 and a plurality of HDDs 30.

[1-3] Description of Hierarchical Storage Controlling Apparatus

Now, details of the hierarchical storage controlling apparatus 10 are described.

As an example, the hierarchical storage controlling apparatus 10 includes a hierarchy management unit 11, a hierarchy driver 12, an SSD driver 13 and an HDD driver 14 as depicted in FIG. 7. It is to be noted that the hierarchy management unit 11 is implemented as a program to be executed in a user space, and the hierarchy driver 12, SSD driver 13 and HDD driver 14 are implemented by a program to be executed in an OS space.

The hierarchy management unit 11 decides, using a blktrace, a segment with regard to which region movement is to be performed based on information of an IO traced with regard to the SSD 20 and/or the HDD 30 and issues an instruction for movement of data of the decided segment to the hierarchy driver 12. Here, the blktrace is a command for tracing an IO on the block IO level. The hierarchy management unit 11 may use an iostat that is a command for confirming a utilization situation of a disk IO in place of the blktrace. It is to be noted that the blkgrace and the iostat are executed in the OS space.

The hierarchy management unit 11 includes a data collection unit 11a, a database 11b, a workload analysis unit 11c, a movement instruction unit 11d and a division number decision unit 11e.

It is to be noted that, in order to implement operation of the hierarchy management unit 11, it is preferable to determine information described below in advance by a manager of the hierarchical storage system 1 or the like.

An average response (without copy) where all segments exist in the HDD 30, and a division number with which the average response is equal to that in the case where no copy is involved. In the example of FIG. 4, the division number is 256. It is to be noted that the average response and the division number are calculated by performing such an experiment as depicted in FIG. 4 using equipment planned to be used in the hierarchical storage system 1.
A time period within which the average response is calculated. For example, approximately 60 s.
An error range of the average response. For example, approximately 50 ms.

The data collection unit 11a collects, using the blctrace, information of IOs traced with regard to the SSD 20 and/or the HDD 30 at predetermined intervals (for example, at intervals of one minute). The data collection unit 11a totalizes, based on the collected information, for example, information for specifying the segment, a totalized number of IOs (iopm; IO per minute) and the average response (response performance) for each segment. Then, the data collection unit 11a writes a result of the totalization into the database 11b together with a timestamp. It is to be noted that, as the information for specifying the segment, information regarding an offset on the volume can be used.

Further, the data collection unit 11a can totalize also a totalized number of IOs and an average response (of all segments) taking all segments as targets and write the totalized data into the database 11b together with a timestamp. At this time, the data collection unit 11a may issue a notification of it to the division number decision unit 11e that information taking all segments as targets is added to the database 11b.

It is to be noted that the data collection unit 11a may totalize a read/write ratio (rw ratio) of IOs to each segment and/or all segments and include the totalized information into the information described above.

In this manner, the data collection unit 11a is an example of a monitoring unit that monitors the response performance to an inputted request regarding a plurality of unit regions obtained by dividing a region used in the SSD 20 or the HDD 30 in a predetermined size.

The database 11b stores information relating to the segments totalized by the data collection unit 11a therein and is implemented, for example, by a memory not depicted or the like.

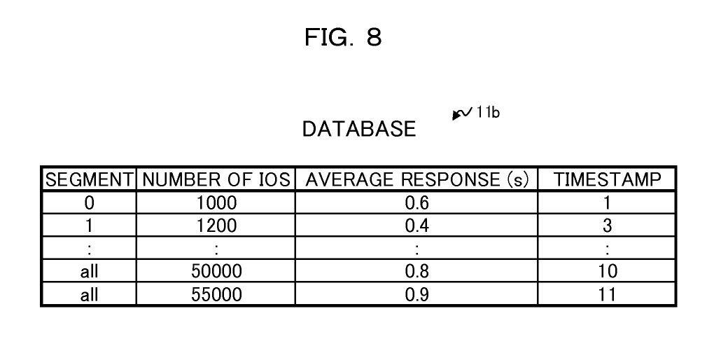

FIG. 8 is a view depicting an example of the database 11b depicted in FIG. 7. As depicted in FIG. 8, the database 11b is a table in which the information for specifying a segment, a number of IOs, an average response and a timestamp are stored in an associated relationship with each other. For example, in the segment indicated as segment “1”, the totalized number of IOs, average response and timestamp are “1000”, “0.6” (seconds) and “1”, respectively.

It is to be noted that, while the segment number is used as the information for specifying a segment, a top offset of a storage volume may be used in place of the segment number. Here, the number of IOs is a totalized number of IOs performed for the segment within one minute, and the average response is an average of time used for a time period until a response is transmitted after the hierarchical storage controlling apparatus 10 receives an IO to a segment. The timestamp is an identifier for specifying time, and, for example, a point of time may be set as it is.

Further, in FIG. 8, an entry in which the segment is “all” is a result of totalization taking all segments as targets. Since, as regards an entry in which the segment is “all”, n data in the past are referred to by the division number decision unit 11e hereinafter described, a plurality of entries of “all” can be added. It is to be noted that whether an entry of “all” is new or old can be identified from the timestamp. On the other hand, an entry of each segment may be set such that data of the same segment can be overwritten or a plurality of data can be registered similarly to “all”.

The workload analysis unit 11c selects a segment whose data is to be moved to the SSD 20 or the HDD 30 from among the segments stored in the database 11b and transfers information relating to the selected segment to the movement instruction unit 11d.

As an example, the workload analysis unit 11c can extract segments in descending order of the number of IOs until the number of the segments reaches a maximum number (predetermined number) of segments whose hierarchical movement is to be performed at the same time. Or, the workload analysis unit 11c may extract, as a segment whose data is to be moved to the SSD 20, a segment whose number of IOs or concentration rate of accesses (rate of the number of IOs to the entire segments) is greater than a predetermined threshold value.

Further, the workload analysis unit 11c can extract, as a segment whose data is to be moved to the HDD 30, for example, a segment on the SSD 20 whose number of IOs is smaller than the predetermined number or whose number of IOs or concentration rate of accesses is lower than the predetermined threshold value.

It is to be noted that, when an extraction condition of a segment whose data is to be moved to the SSD 20 or the HDD 30 is satisfied successively by a predetermined number of times, the workload analysis unit 11c may extract the segment as a segment whose data is to be moved to the SSD 20 or the HDD 30. Further, the workload analysis unit 11c may select a segment based not only on the number of IOs or the like described above but also on the read/write ratio (rw ratio).

Here, after an instruction for hierarchical movement of the segments in the HDD 30 to the SSD 20 is issued, the workload analysis unit 11c can issue an instruction for hierarchical movement of the other segments in the SSD 20 to the HDD 30 to the movement instruction unit 11d. On the other hand, when it is predicted that the load to a certain segment decreases within a period within which hierarchical movement of the segment to the SSD 20 is performed, the workload analysis unit 11c may issue an instruction for hierarchical movement only of the other segments to the HDD 30.

For example, the workload analysis unit 11c can determine whether or not the load to the segment during hierarchical movement decreases based on average life expectancy time of a spike and time to be used for the hierarchical movement. It is to be noted that the spike signifies that a load is concentrated on some of the segments, and the average like expectancy time signifies time calculated by subtracting execution time already used for execution from a continuous time period within which the load continues and is a value determined in response to a workload. The manager or the like can calculate the average like expectancy time and set the calculated time to the hierarchical storage controlling apparatus 10 in advance.

In particular, the workload analysis unit 11c extracts a segment whose data is to be moved to the SSD 20 and calculate the cost (time) to be used for movement of the data of the extracted segment to the SSD 20. Then, when the average like expectancy time is shorter than the movement time, the workload analysis unit 11c can determine that only the hierarchical movement from the SSD 20 to the HDD 30 is to be performed.

The movement instruction unit 11d issues an instruction for movement of data of a selected segment from the HDD 30 to the SSD 20 or from the SSD 20 to the HDD 30 to the hierarchy driver 12 based on an instruction from the workload analysis unit 11c. At this time, the movement instruction unit 11d converts an offset of the selected segment on the storage volume into an offset on the HDD 30 and issues an instruction for movement of the data for each segment. For example, if an offset on the volume is 1 GB where the sector size of the HDD 30 is 512 B, then the offset on the HDD 30 is 1×1024×1024×1024/512=2097152.

Further, the movement instruction unit 11d issues a movement starting notification including a number of segments with regard to which a movement instruction is issued and a timestamp (latest timestamp) of the data with regard to which the decision of movement is performed by the workload analysis unit 11c to the division number decision unit 11e.

The division number decision unit 11e determines the division number of a segment and changes the division number dynamically based on variation of the IO response before and after starting of the movement of the data of the segment.

In particular, if the movement starting notification is received from the movement instruction unit 11d, then the division number decision unit 11e issues a notification of an immediately preceding result of the decision of the division number (initial value just after startup, for example, 256) to the hierarchy driver 12 (division unit 12d). The hierarchy driver 12 performs division of the segment in accordance with the division number received as a notification and processes the data movement.

Further, the division number decision unit 11e acquires an average response just before segment movement calculated by the data collection unit 11a and calculates an anticipated value of the average response during segment movement based on an average response error range value determined in advance. It is to be noted that the average response just before the segment movement can be acquired by extracting “average response taking all segments as targets” in the database 11b corresponding to the timestamp included in the movement starting notification. For example, where the average response is 400 ms and the average response error range value is 50 ms, the range from 350 ms to 450 ms is the anticipated value.

Further, if a response is newly inputted during segment movement, then the division number decision unit 11e evaluates whether or not the average response is within the range of the anticipated value.

In particular, if a predetermined number of (for example, n) average responses taking all segments as targets is calculated by the data collection unit 11a, then the division number decision unit 11e calculates an average value of the n data and determines the calculated value as the average response during segment movement. Then, if the average response during segment movement is higher than the anticipated value (response performance is degraded), then the division number decision unit 11e increases the division number of segments to a value greater than the present set value and issues a notification of the increased division number to the hierarchy driver 12. On the other hand, if the average response during segment movement is lower than the anticipated value (response performance is superior), then the division number decision unit 11e decreases the division number of segments to a value lower than the present set value and issues a notification of the decreased division number to the hierarchy driver 12.

For example, when the division number is to be increased from the present set value, the division number decision unit 11e may vary the division number to two times (for example, from 256 to 512), three times and . . . or may increment the division number by a predetermined value. Further, when the division number is to be decreased value lower than the present setting value, the division number decision unit 11e may vary the division number to ½ time (for example, from 256 to 128), ⅓ time, . . . or may decrement the division number by a predetermined value.

In this manner, where the average response during segment movement is outside of the anticipated value, the division number decision unit 11e dynamically changes the division number during segment movement so that the average response upon region movement falls within a range of the anticipated value based on the response just before the movement. Consequently, by the segment movement, the response is prevented from being degraded from the response before the segment movement taking the response as a reference and the stability of the system can be guaranteed.

It is to be noted that, by using the average value of a plurality of (n) average responses monitored at a plurality of time points during hierarchical movement by the data collection unit 11a, the division number decision unit 11e can relax the influence of sudden variation of a workload in such a case that accesses are concentrated within a very short period of time.

It is to be noted that, while it has been described that the division number decision unit 11e changes the division number based on a first response performance during execution of the movement process and a second response performance before execution of the movement process monitored by the data collection unit 11a, the change of the division number is not limited to this.

For example, the division number decision unit 11e may vary the division number based on a response performance during execution of the movement process. As an example, the division number decision unit 11e acquires responses based on the division number issued as a notification to the hierarchy driver 12 during segment movement, and increases or decreases the division number and acquires a response at the time. Then, the division number decision unit 11e compares a plurality of responses acquired during the segment movement with each other, and can vary the division number as described above in response to whether or not the latest response is greater than an immediately preceding response (whether or not the response performance is degraded). It is to be noted that the division number decision unit 11e may vary the division number if the difference between the compared responses exceeds an error range value for the average response.

As described above, the division number decision unit 11e is an example of a changing unit that changes the division number based on the first response performance during execution of a movement process monitored by the data collection unit 11a.

It is to be noted that, while it has been described that the division number decision unit 11e determines a division number for segments and issues a notification of the determined division number to the hierarchy driver 12 (division unit 12d), the division number decision unit 11e may otherwise determine a movement unit when movement of a unit region of a movement target is to be performed and issue a notification of the determined movement unit. In particular, the division number decision unit 11e may determine (vary) the data size (size of the movement unit) to be transferred at a time regarding a segment that is a movement target in accordance with the decision described above and may issue a notification of a result of the determination to the hierarchy driver 12.

The hierarchy driver 12 includes an IO map unit 12a, a pending queue 12b, a hierarchy table 12c and a division unit 12d.

The IO map unit 12a distributes an IO request from the user to the storage volume to the SSD driver 13 or the HDD driver 14 using the hierarchy table 12c and returns an IO response from the SSD driver 13 or the HDD driver 14 to the user.

The pending queue 12b is a retention unit for temporarily storing an IO request therein and is implemented by a memory not depicted or the like. If an IO request is issued relating to a segment during hierarchical movement, then the IO map unit 12a stores the IO request into the pending queue 12b and leaves the IO request pending until movement of data of the segment is completed. If the movement of the data is completed, then the IO map unit 12a reads out the IO request from the pending queue 12b and restarts distribution of an IO request to the SSD driver 13 or the HDD driver 14.

The hierarchy table 12c is a table used for distribution of an IO request by the IO map unit 12a and hierarchy control by the division unit 12d and is implemented, for example, by a memory not depicted or the like.

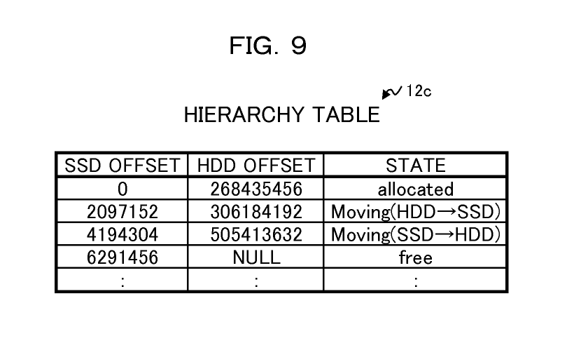

FIG. 9 is a view depicting an example of the hierarchy table 12c depicted in FIG. 7. As depicted in FIG. 9, the hierarchy table 12c is a table for storing an SSD offset, an HDD offset and a status in an associated relationship with each other for each segment whose data is moved to the SSD 20.

The SSD offset indicates an offset of a segment whose data is moved to the SSD 20 in the SSD 20. The SSD offset is a fixed value taking, as a unit, an offset “2097152” corresponding to the size 1 GB on the volume, and is, for example, “0”, “2097152”, “4194304”, “6291456”, . . . .

The HDD offset indicates an offset of segment whose data is moved to the SSD 20 in the HDD 30. A value “NULL” of the HDD offset indicates that a region of the SSD 20 designated by the SSD offset is not used.

The status indicates a state of a segment, and is “allocated”, “Moving (HDD to SDD)”, “Moving (SSD to HDD)” or “free”. “allocated” indicates that the segment is allocated to the SSD 20, and “Moving (HDD to SSD)” indicates that data of the segment is being transferred from the HDD 30 to the SSD 20. “Moving (SSD to HDD)” indicates that data of the segment is being transferred from the SSD 20 to the HDD 30, and “free” indicates that a region of the SSD 20 designated by the SSD offset is not used.

The IO map unit 12a can refer to the hierarchy table 12c described above to decide to which one of the SSD driver 13 and the HDD driver 14 the IO request is to be distributed and decide whether or not the IO request is that the segment movement is being performed.

Referring back to the description of FIG. 7, if a segment movement instruction is received from the movement instruction unit 11d, then the hierarchy driver 12 executes a movement process for moving data stored in a unit region of a movement target of the HDD 30 or the SSD 20 to the SSD 20 or the HDD 30. In particular, the hierarchy driver 12 moves data of the segment designated by the segment movement instruction between the SSD 20 and the HDD 30 based on the hierarchy table 12c and the division unit 12d.

More particularly, if the segment movement instruction is received, then the hierarchy driver 12 searches an entry of “NULL” from the HDD offset in the hierarchy table 12c and registers HDD offset information and the state designated by the segment movement instruction. It is to be noted that the state to be registered at this time is “Moving (HDD to SSD)” or “Moving (SSD to HDD)”. Then, the hierarchy driver 12 transmits a notification of a transfer instruction of the data between the SSD 20 and the HDD 30 to the division unit 12d.

Further, if transfer completion of data is received as a notification, then the hierarchy driver 12 searches an entry indicating completion of transfer from the hierarchy table 12c and changes, where the state is “Moving (HDD to SSD)”, the state into “allocated”. On the other hand, where the state is “Moving (SSD to HDD)”, the hierarchy table 12c changes the state to “free” and sets a corresponding HDD offset to “NULL”.

The division unit 12d divides the segment by the division number issued as an instruction from the division number decision unit 11e in response to the transfer instruction of data between the SSD 20 and the HDD 30 from the hierarchy driver 12 and performs hierarchical movement of the data of the segment.

In particular, if the transfer instruction is received from the hierarchy driver 12, then the division unit 12d divides each segment relating to the transfer instruction by the division number mm issued as an instruction from the division number decision unit 11e and issues a notification of the transfer instruction to the kcopyd in a unit of a divisional region. Then, if transfer of the data in all of the divisional regions is completed by the kcopyd, then the division unit 12d issues a notification of the transfer completion of the data to the hierarchy driver 12.

Further, if an update request for the division number mm is received from the division number decision unit 11e, then the division unit 12d performs updating of the division number mm in response to the request. For example, if an instruction for increasing the division number to two times is received as a notification, then the division unit 12d calculates mm=mm*2 and updates the division number mm. Further, if an instruction for decreasing the division number to ½ time is received as a notification, then the division unit 12d calculate mm=mm/2 and updates the division number mm.

It is to be noted that the division unit 12d can use, as a division number (movement unit) when the transfer instruction of data is received from the hierarchy driver 12, a predetermined division number (movement unit) calculated based on a response before segment movement (for example, just before movement) by the division number decision unit 11e. Consequently, since the division number (movement unit) is set taking a response before segment movement into consideration, sudden degradation of a response when transfer of data by the kcopyd is started can be suppressed.

In this manner, the division unit 12d divides the unit region of the movement target into a plurality of divisional regions by the predetermined division number and moves the data stored in the unit region of the movement target to the SSD 20 or the HDD 30 in a unit of a divisional region. In other words, the division unit 12d changes the movement unit of the unit region of the movement target in response to the instruction from the division number decision unit 11e and issues an instruction for data transfer to the kcopyd in a changed movement unit.

The SSD driver 13 controls accessing to the SSD 20 based on the instruction of the hierarchy driver 12. The HDD driver 14 controls accessing to the HDD 30 based on the instruction of the hierarchy driver 12.

As described above, with the hierarchy storage system 1 according to the present embodiment, the average response of the user IO can be monitored and the movement unit can be set (changed) dynamically to a region size with which response degradation converges in response to the response variation of the user IO. Accordingly, response degradation to the user IO and a balance between hierarchical movement time periods can be suitably solved and hierarchical movement of a segment can be implemented by a division number as small as possible (within a short time period).

In particular, with the hierarchy storage system 1 according to the present embodiment, by the division number decision unit 11e and the division unit 12d, hierarchical movement of data between the SSD 20 and the HDD 30 can be performed in an optimum movement unit in response to a performance of equipment to be used or a workload.

[1-4] Example of Operation of Hierarchy Storage System

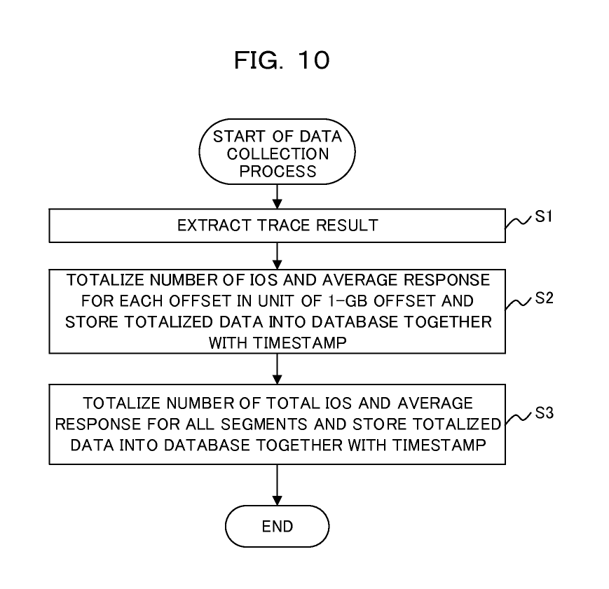

Now, an example of operation of the hierarchy storage system 1 configured in such a manner as described above is described with reference to FIGS. 10 to 18.

First, operation of the data collection unit 11a is described with reference to FIG. 10. FIG. 10 is a flow chart illustrating an example of operation of a data collection process by the data collection unit 11a. It is to be noted that the data collection unit 11a is started up taking, as a condition, that a blktrace command is executed for 60 seconds and then ends.

As depicted in FIG. 10, by the data collection unit 11a, a result of trace obtained by execution of the blktrace command is extracted (step S1). Then, by the data collection unit 11a, a number of IOs and an average response of each segment are totalized in a unit of a 1-GB offset, namely, in a unit of segment, and the totalized data are written into the database 11b together with a timestamp (step S2).

Then, by the data collection unit 11a, the totalized number of IOs and the average responses are totalized taking all segments as targets and the totalized data are stored into the database 11b together with a timestamp (step S3). It is to be noted that the data collection unit 11a may issue a notification that the process at step S3 is executed to the division number decision unit 11e.

In this manner, the data collection unit 11a can feed back an influence of a workload that varies fluidly on the user IO by periodically monitoring the average responses of all segment.

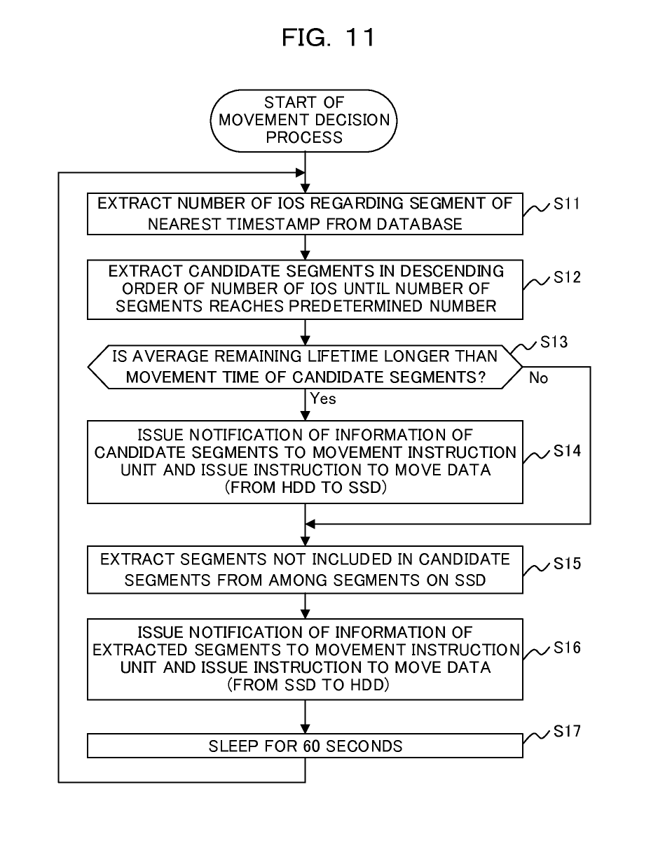

Then, operation of the workload analysis unit 11c is described with reference to FIG. 11. FIG. 11 is a flow chart illustrating an example of operation of a movement decision process by the workload analysis unit 11c.

As depicted in FIG. 11, by the workload analysis unit 11c, a number of IOs is extracted regarding a segment having the latest timestamp from the database 11b (step S11). Then, by the workload analysis unit 11c, a candidate segment is extracted in a descending order of a number of IOs until the segment number reaches a predetermined number (step S12).

Then, by the workload analysis unit 11c, it is decided whether or not average life expectancy time calculated in advance is longer than movement time to be used for all candidate segments (step S13). If the average life expectancy time is equal to or shorter than the movement time (No route at step S13), then the processing advances to step S15. On the other hand, if the average life expectancy time is longer than the movement time (Yes route at step S13), then, by the workload analysis unit 11c, information of the candidate segments is issued as a notification to the movement instruction unit 11d and an instruction for movement of data (from the HDD 30 to the SSD 20) is issued (step S14).

At step S15, by the workload analysis unit 11c, a segment not included in the candidate segments, namely, a segment whose number of IOs is comparatively small, is extracted from the segments on the SSD 20. Then, by the workload analysis unit 11c, information of the extracted segment is issued as a notification to the movement instruction unit 11d and an instruction for movement of data (from the SSD 20 to the HDD 30) is issued (step S16).

Then, the workload analysis unit 11c sleeps for a predetermined time period, for example, for 60 seconds (step S17), and the processing advances to step S11.

It is to be noted that, at step S12, the workload analysis unit 11c may extract a segment whose number of IOs or concentration rate of accesses (ratio of the number of IOs with respect to the entire IOs) is greater than a predetermined threshold value. Further, at step S15, as a segment whose data is to be moved to the HDD 30, the workload analysis unit 11c may extract, for example, a segment on the SSD 20 whose number of IOs or whose concentration rate of accesses is equal to or smaller than a predetermined threshold value. Further, as a segment to be extracted at steps S12 and S15, the workload analysis unit 11c may select a segment that satisfies the extraction condition successively by more than a predetermined number of times.

In this manner, by issuing an instruction from the workload analysis unit 11c to the movement instruction unit 11d to move data of a segment to which the concentration degree of IOs is high is moved from the HDD 30 to the SSD 20, the user can access the data of the HDD 30 at a high speed. Further, by issuing an instruction from the workload analysis unit 11c to the movement instruction unit 11d to move data of a segment to which the concentration degree of IOs is low is moved from the SSD 20 to the HDD 30, the SSD of a comparatively high price and a low capacity can be effectively utilized.

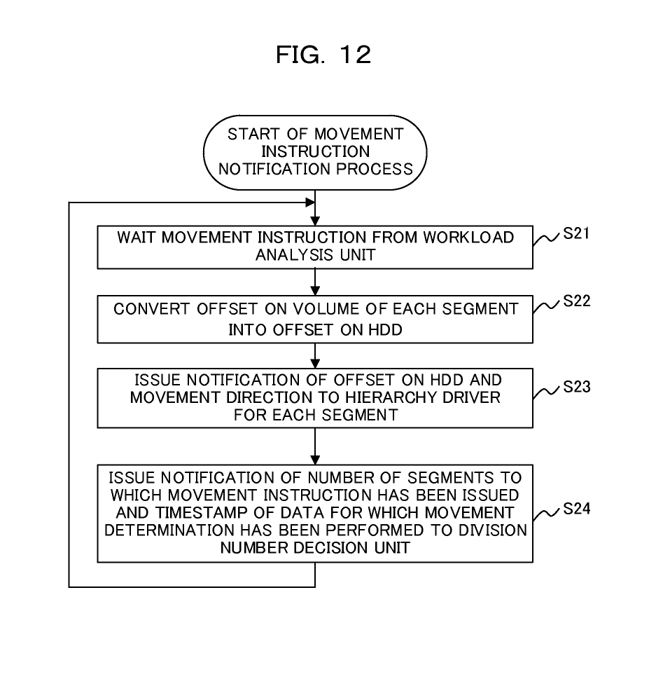

Now, operation of the movement instruction unit 11d is described with reference to FIG. 12. FIG. 12 is a flow chart illustrating an example of operation of a movement instruction notification process by the movement instruction unit 11d.

As depicted in FIG. 12, by the movement instruction unit 11d, the movement instruction from the workload analysis unit 11c is waited (step S21). If the movement instruction is received, then, by the movement instruction unit 11d, an offset on a volume of each segment is converted into an offset on the HDD 30 (step S22).

Then, by the movement instruction unit 11d, a notification of the offset on the HDD 30 and a movement direction of the data is issued for each segment (step S23). Here, the movement direction of the data signifies transfer from the HDD 30 to the SSD 20 or transfer from the SSD 20 to the HDD 30. Then, by the movement instruct ion unit 11d, a notification of the number of segment with regard to which the movement instruction is issued and a timestamp (latest timestamp) of the data with regard to which the movement determination is performed is issued to the division number decision unit 11e (step S24), whereafter the processing advances to step S21.

In this manner, by converting an offset of each segment on a volume into an offset of the HDD 30 by the movement instruction unit 11d, the hierarchy driver 12 can move data between the SSD 20 and the HDD 30.

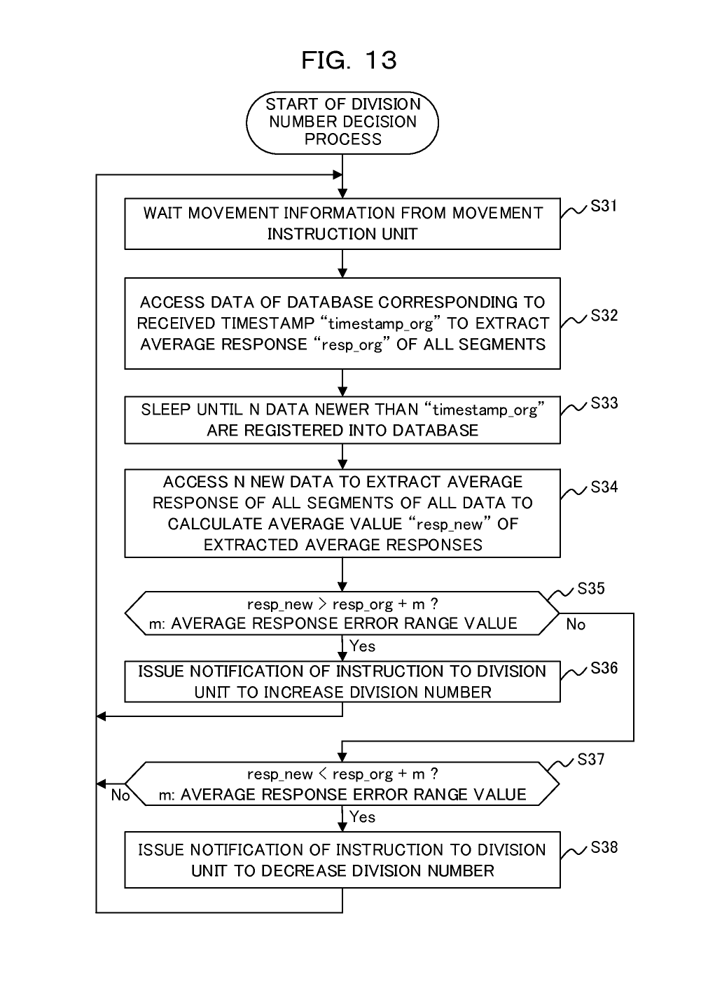

Now, operation of the division number decision unit 11e is described with reference to FIG. 13. FIG. 13 is a flow chart illustrating an example of operation of a division number decision process by the division number decision unit 11e.

As depicted in FIG. 13, by the division number decision unit 11e, movement information (number of segments, timestamp) of a segment from the movement instruction unit 11d is waited (step S31). If the movement information is received, then, by the division number decision unit 11e, accessing to data of the database 11b corresponding to the received timestamp timestamp_org is performed, and an average response resp_org of all segments is extracted (step S32).

Then, the division number decision unit 11e sleeps until n data having a newer timestamp than the timestamp_org are registered into the database 11b (for example, 60×n+10 seconds) (step S33).

If n new data are registered into the database 11b, then, by the division number decision unit 11e, accessing to the n new data is performed and an average response of all segments of all data is extracted. Then, by the division number decision unit 11e, an average value resp_new of the extracted average response is calculated (step S34).

Then, by the division number decision unit 11e, it is decided whether or not resp_new>resp_org+m is satisfied (step S35). If resp_new>resp_org+m is satisfied (Yes route at step S35), then by the division number decision unit 11e, an instruction for causing the division unit 12d to increase the division number (for example, the division number is increased to two times of the present division number) is issued (step S36), and then the processing advances to step S31. It is to be noted that m is an error range value of the average response and can be set, for example, to 50 ms.

On the other hand, if resp_new>resp_org+m is not satisfied (No route at step S35), then by the division number decision unit 11e, it is decided whether or not resp_new<resp_org+m is satisfied (step S37). If resp_new<resp_org+m is satisfied (Yes route at step S37), then by the division number decision unit 11e, an instruction for causing the division unit 12d to decrease the division number (for example, the division number is decreased to ½ time of the present division number) is issued (step S38), and then the processing advances to step S31. It is to be noted that, if the resp_new<resp_org+m is not satisfied (No route at step S37), then since the resp_new is within a range of the anticipated value of the average response, updating of the division number is not performed and the processing advances to step S31.

In this manner, the division number decision unit 11e can determine the division number such that degradation of the average response by the segment movement is suppressed based on the average response before and during the segment movement. Accordingly, since the hierarchy driver 12 can divide the segment during movement dynamically into an optimum division number, response degradation to the user IO relating to the target data can be suppressed while the moving time period is decreased.

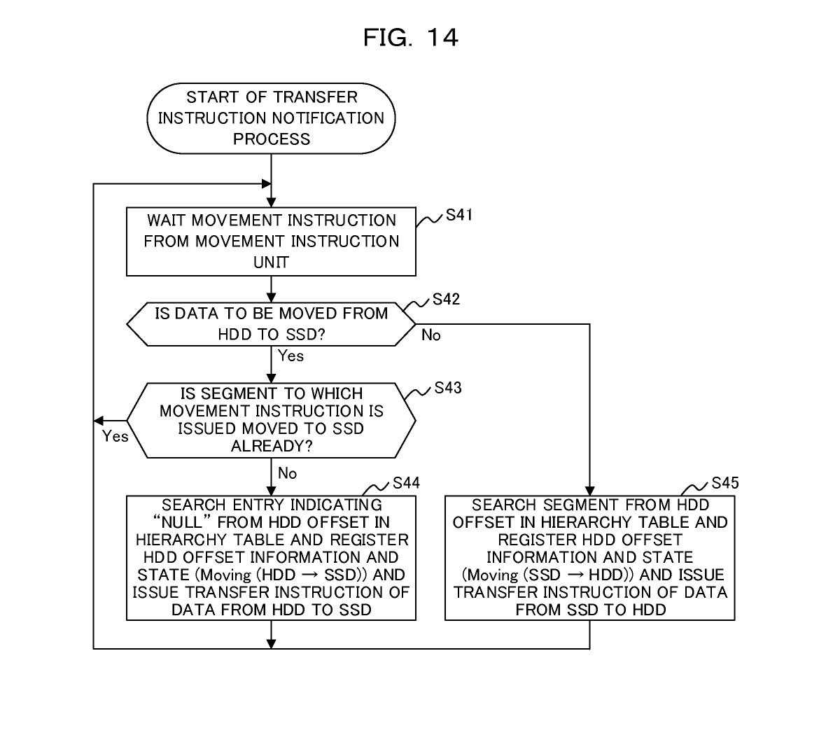

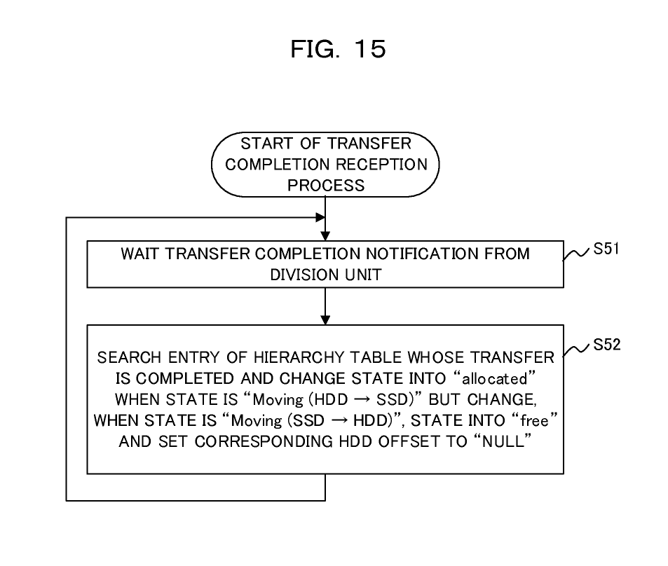

Then, operation of the hierarchy driver 12 is described with reference to FIGS. 14 and 15.

First, operation of the hierarchy driver 12 when the movement instruction is received is described. FIG. 14 is a flow chart illustrating an example of operation of a transfer instruction notification process by the hierarchy driver 12.

As depicted in FIG. 14, by the hierarchy driver 12, a movement instruction from the movement instruction unit 11d is waited (step S41), and, if the movement instruction is received, then it is decided whether or not the received instruction is movement of data from the HDD 30 to the SSD 20 (step S42).

If the received instruction is movement of data from the HDD 30 to the SSD 20 (Yes route at step S42), then by the hierarchy driver 12, it is decided whether or not a segment whose movement is instructed is moved to the SSD 20 already (step S43). If the segment whose movement is instructed is moved to the SSD 20 already (Yes route at step S43), then the processing advances to step S41.

On the other hand, if the segment whose movement is instructed is not moved to the SSD 20 as yet (No route at step S43), then by the hierarchy driver 12, an entry indicating “NULL” is searched from the HDD offset in the hierarchy table 12c and the HDD offset information and the state are registered. At this time, the state to be registered in the hierarchy driver 12 is “Moving (HDD to SSD)”. Then, by the hierarchy driver 12, a transfer instruction for data from the HDD 30 to the SSD 20 is issued to the division unit 12d (step S44), and the processing advances to step S41.

On the other hand, if the received instruction is not movement of data from the HDD 30 to the SSD 20 (No route at step S42), then by the hierarchy driver 12, a segment is searched from the HDD offset in the hierarchy table 12c, and the HDD offset information and the state are registered. At this time, the state to be registered in the hierarchy driver 12 is “Moving (SSD to HDD)”. Then, by the hierarchy driver 12, a transfer instruction for data from the SSD 20 to the HDD 30 is issued to the division unit 12d (step S45), and the processing advances to step S41.

Now, operation of the hierarchy driver 12 when a transfer completion notification is received after transfer instruction is described. FIG. 15 is a flow chart illustrating an example of operation of a transfer completion reception process by the hierarchy driver 12.

As depicted in FIG. 15, by the hierarchy driver 12, a transfer completion notification from the division unit 12d is waited (step S51). If the transfer completion notification is received, then by the hierarchy driver 12, an entry of the hierarchy table 12c with regard to which transfer is completed is searched using the HDD offset and, if the state is “Moving (HDD to SSD)”, then the state is changed to “allocated”. On the other hand, by the hierarchy table 12c, if the state is “Moving (SSD to HDD)”, then the state is changed to “free” and the corresponding HDD offset is set to “NULL” (step S52), and then the processing advances to step S51.

In this manner, by transferring data between the SSD 20 and the HDD 30 using the hierarchy table 12c by the hierarchy driver 12, data of a segment on which IOs are concentrated can be placed into the SSD 20.

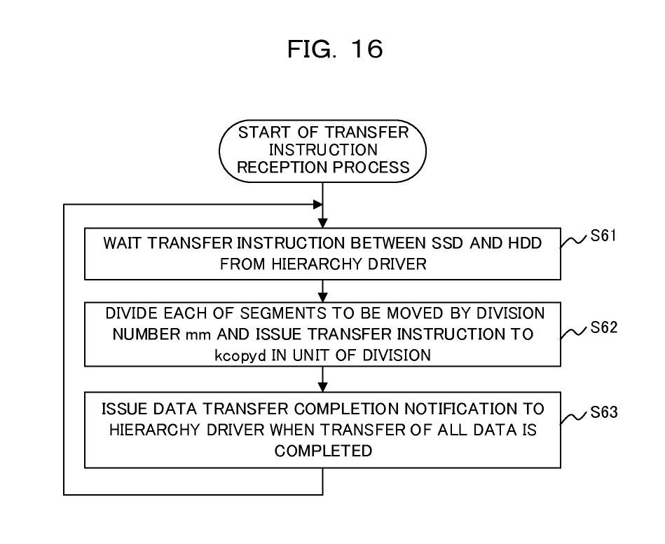

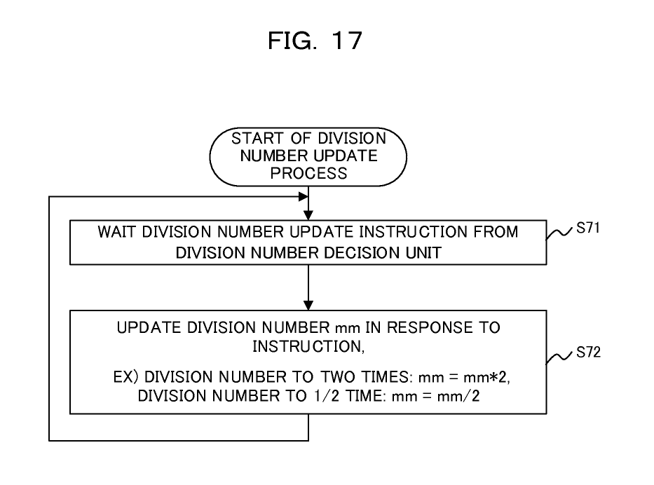

Now, operation of the division unit 12d is described with reference to FIGS. 16 and 17.

First, operation of the division unit 12d when a transfer instruction is received is described. FIG. 16 is a flow chart illustrating an example of operation of a transfer instruction reception process by the division unit 12d.

As depicted in FIG. 16, by the division unit 12d, a transfer instruction between the SSD 20 and the HDD 30 from the hierarchy driver 12 is waited (step S61). If the transfer instruction is received, then by the division unit 12d, each segment designated based on the transfer instruction so as to be moved is divided by the division number mm and a transfer instruction is issued to the kcopyd in a unit of a division (step S62).

If transfer of all data ends, then by the division unit 12d, a notification of transfer completion of the data is issued to the hierarchy driver 12 (step S63), and the processing advances to step S61.

Now, operation of the division unit 12d when a division number updating instruction is received is described. FIG. 17 is a flow chart illustrating an example of operation of a division number updating process by the division unit 12d.

As depicted in FIG. 17, by the division unit 12d, a division number updating instruction from the division number decision unit 11e is waited (step S71). If the division number updating instruction is received, then by the division unit 12d, the division number mm is updated in response to the received instruction (step S72), and the processing advances to step S71.

In this manner, by dividing the transfer instruction in a segment unit from the hierarchy driver 12 into smaller moving units by the division unit 12d, response degradation of the user IO can be suppressed. Further, since the division unit 12d can suitably update the division number mm in response to the division number updating instruction from the division number decision unit 11e, variation of the workload can be coped with flexibly.

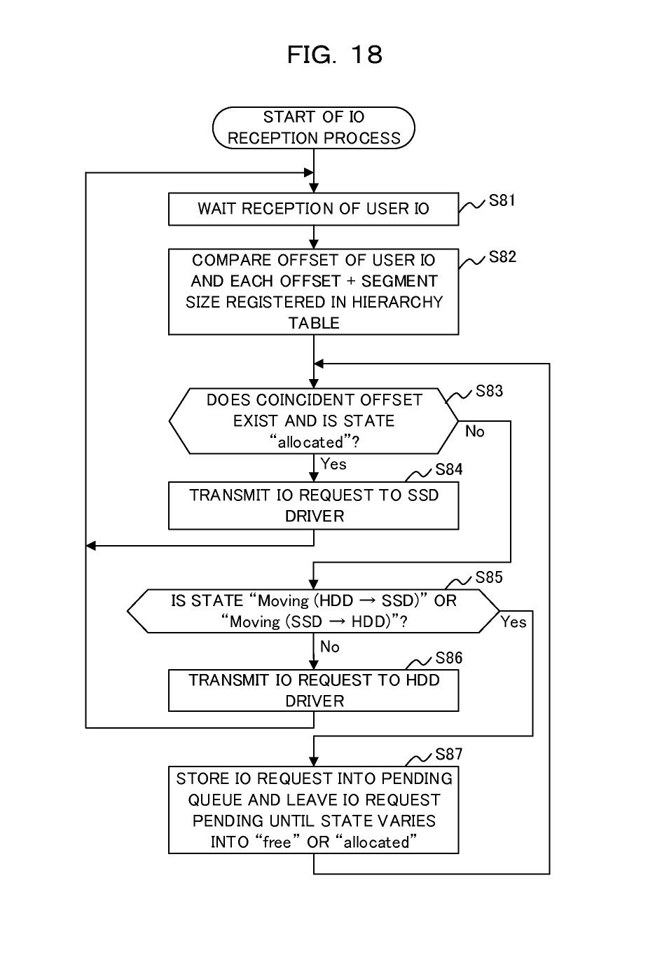

Now, operation of the IO map unit 12a is described with reference to FIG. 18. FIG. 18 is a flow chart illustrating an example of operation of an IO reception process by the IO map unit 12a.

As depicted in FIG. 18, by the IO map unit 12a, reception of a user IO is waited (step S81). If the user IO is received, then by the IO map unit 12a, an “offset” designated by the user IO and each “offset+segment size” registered in the hierarchy table 12c are compared with each other (step S82).

Then, by the IO map unit 12a, it is decided from a result of the comparison whether or not an offset that coincides with the designated offset exists in the hierarchy table 12c and besides the state is “allocated” (step S83). If an offset that coincides with the designated offset exists in the hierarchy table 12c and the state is “allocated” (Yes route at step S83), then by the IO map unit 12a, an IO request is transmitted to the SSD driver 13 (step S84), and the processing advances to step S81.

On the other hand, if an offset that coincides with the designated offset does not exist or the state is not “allocated” (No route at step S83), then by the IO map unit 12a, it is decided whether or not the state is “Moving (HDD to SSD)” or “Moving (SSD to HDD)” (step S85). If the state is not “Moving (HDD to SSD)” or “Moving (SSD to HDD)” (No route at step S85), by the IO map unit 12a, an IO request is transmitted to the HDD driver 14 (step S86), and the processing advances to step S81.

However, if the state is “Moving (HDD to SSD)” or the “Moving (SSD to HDD)” (Yes route at step S85), then by the IO map unit 12a, an IO request is stored into the pending queue 12b until the state varies to “free” or “allocated”. In particular, by the IO map unit 12a, the IO request is left pending until the hierarchical movement of the segment relating to the IO request is completed (step S87). If the hierarchical movement is completed, then the IO request stored in the pending queue 12b by the IO map unit 12a is extracted and the process advances to step S83.

[1-5] Example of Hardware Configuration

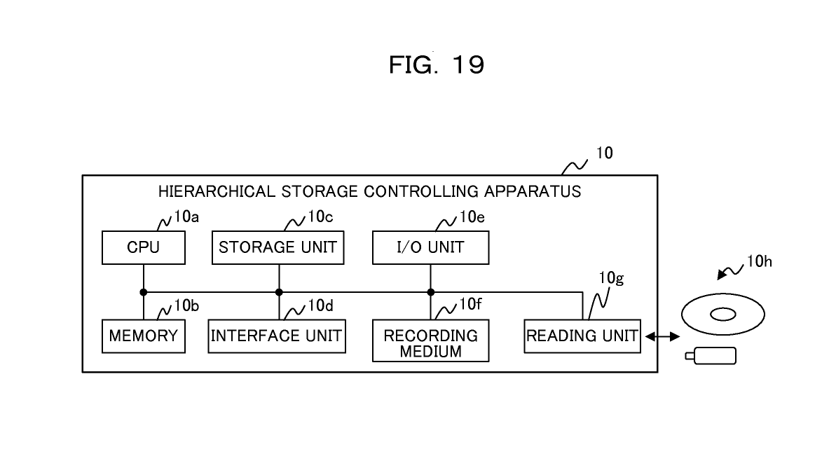

Now, a hardware configuration of the hierarchical storage controlling apparatus 10 depicted in FIG. 7 is described with reference to FIG. 19. FIG. 19 is a view depicting an example of a hardware configuration of the hierarchical storage controlling apparatus 10 depicted in FIG. 7.

As depicted in FIG. 19, the hierarchical storage controlling apparatus 10 includes a Central Processing Unit (CPU) 10a, a memory 10b, a storage unit 10c, an interface unit 10d, an inputting and outputting (I/O) unit 10e, a recording medium 10f and a reading unit 10g.

The CPU 10a is an arithmetic processing apparatus (processor) that is coupled with the corresponding blocks 10b to 10g and performs various controls and arithmetic operations. The CPU 10a executes a program stored in the memory 10b, storage unit 10c, or recording medium 10f or in a recording medium 10h, or a Read Only Memory (ROM) not depicted or the like to implement various functions of the hierarchical storage controlling apparatus 10.

The memory 10b is a storage apparatus for storing various kinds of data or programs therein. The CPU 10a stores and develops data or a program into the memory 10b when the program is to be executed. It is to be noted that, as the memory 10b, a volatile memory such as, for example, a Random Access Memory (RAM) is available.

The storage unit 10c is hardware for storing various kinds of data, programs or the like therein. As the storage unit 10c, various devices such as, for example, a magnetic disk apparatus such as an HDD, a semiconductor drive apparatus such as an SSD and a nonvolatile memory such as a flash memory are available. It is to be noted that a plurality of devices may be used as the storage unit 10c, and a Redundant Arrays of Inexpensive Disks (RAID) may be configured from the devices. Further, the storage unit 10c may include the SSD 20 and the HDD 30 depicted in FIG. 7.

The interface unit 10d performs control of coupling and communication with a network (not depicted) or some other information processing apparatus by cable connection or wireless connection and so forth. As the interface unit 10d, for example, an adapter in compliance with a Local Area Network (LAN), a Fibre Channel (FC), InfiniBand or the like is available.

The (I/O) unit 10e includes at least one of an inputting apparatus such as a mouse or a keyboard and an outputting apparatus such as a display unit or a printer. For example, the (I/O) unit 10e is used for various works by the user, manager or the like of the hierarchical storage controlling apparatus 10.

The recording medium 10f is a storage apparatus such as, for example, a flash memory or a ROM and can record various kinds of data or programs therein. The reading unit 10g is an apparatus for reading out data or a program recorded on the (non-transitory) computer-readable recording medium 10h. A controlling program for implementing part or all of the various functions of the hierarchical storage controlling apparatus 10 according to the present embodiment may be stored in at least one of the recording mediums 10f and 10h. For example, the CPU 10a can develop a program read out from the recording medium 10f or a program read out from the recording medium 10h through the reading unit 10g in a storage apparatus such as the memory 10b and can execute the developed program. Consequently, the computer (including the CPU 10a, information processing apparatus and various terminals) can implement the functions of the hierarchical storage controlling apparatus 10 described above.

It is to be noted that, as the recording medium 10h, for example, an optical disk such as a flexible disk, a Compact Disk (CD), a Digital Versatile Disk (DVD) or a Blu-ray disk and a flash memory such as a Universal Serial Bus (USB) memory or an SD card are available. It is to be noted that, as a CD, a CD-ROM, a CD-Recordable (CD-R), a CD-Rewritable (CD-RW) or the like is available. Further, as a DVD, a DVD-ROM, a DVD-RAM, a DVD-R, a DVD-RW, a DVD+R, a DVD+RW or the like is available.

It is to be noted that the blocks 10a to 10g described above are coupled for communication with each other through a bus. For example, the CPU 10a and the storage unit 10c are coupled with each other through a disk interface. Further, the hardware configuration described above of the hierarchical storage controlling apparatus 10 is an example. Accordingly, increase or decrease of the number of pieces of hardware (for example, addition or omission of an arbitrary block), division, integration in an arbitrary combination of pieces of hardware in the hierarchical storage controlling apparatus 10, addition or omission of a bus or the like may be performed suitably.

[1-6] Example of Application

As described above, the hierarchical storage controlling apparatus 10 is suitable for use for dynamic hierarchy control for moving data in a high-load region to the SSD 20 based on a load measured on the real time basis.

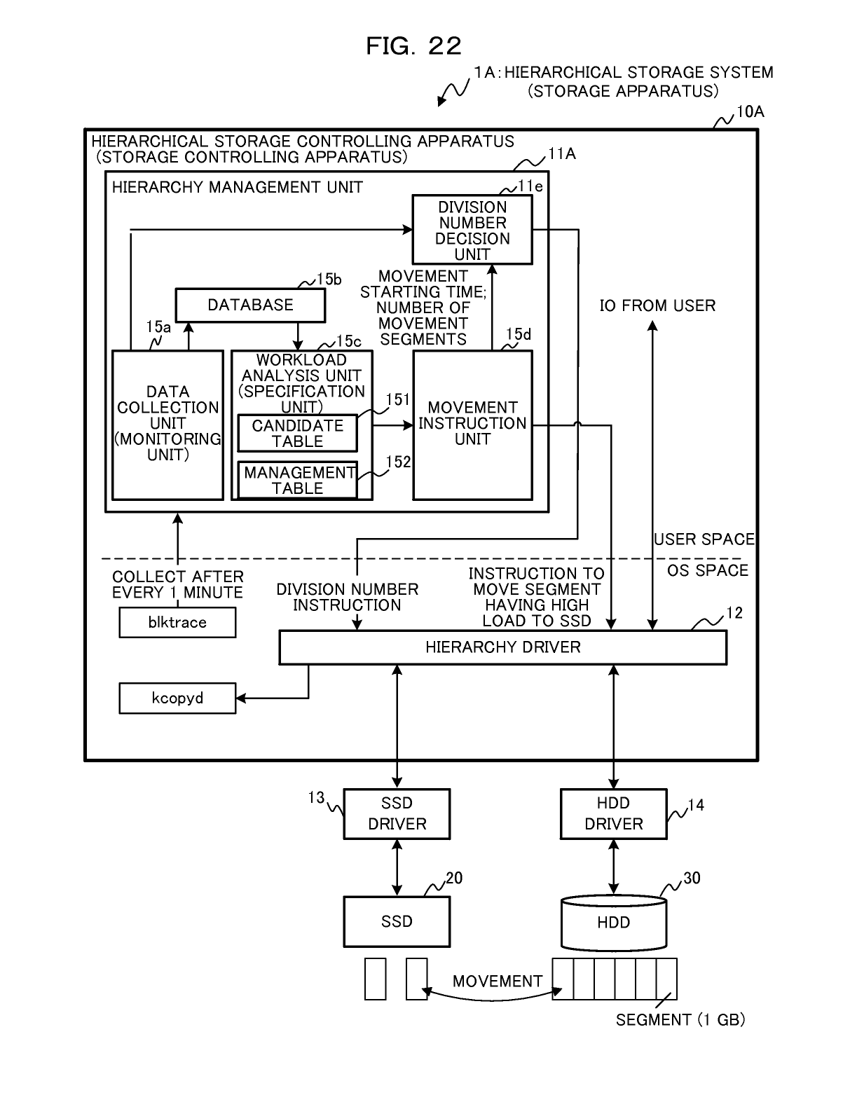

Here, the hierarchical storage controlling apparatus 10 may further include a function for selecting, in order to move data in the proximity of a high-load region to the SSD 20, a suitable region as a proximal region. In particular, the hierarchical storage controlling apparatus 10 may be applied to a hierarchical storage controlling apparatus 10A (refer to FIG. 22) described in detail below.

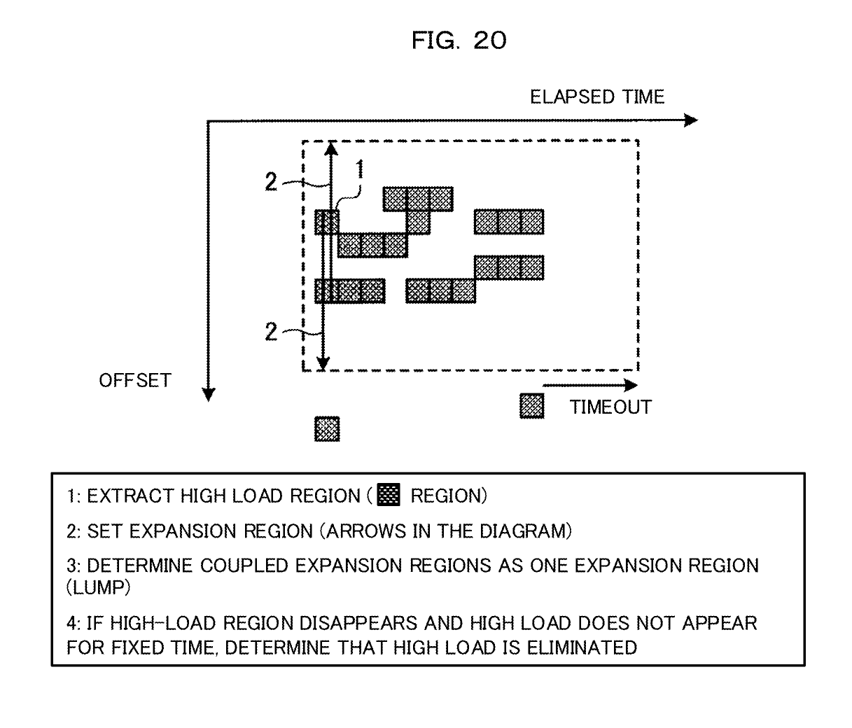

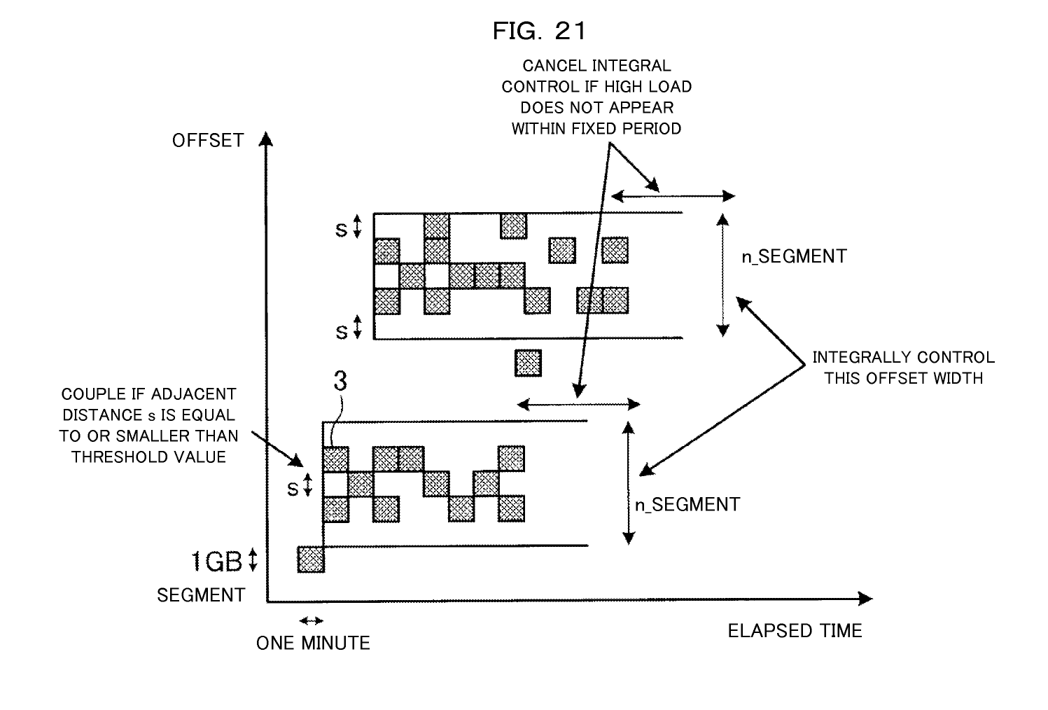

First, a dynamic hierarchy control by the hierarchical storage controlling apparatus 10A according to a present example of application is described. FIGS. 20 and 21 are views illustrating the dynamic hierarchy control by the hierarchical storage controlling apparatus 10A according to the present application example.

FIG. 20 is a view depicting an example of analysis of a workload of a hierarchical storage system 1A (refer to FIG. 22) according to the present application example, and in FIG. 20, the axis of ordinate indicates an offset in a downward direction and the axis of abscissa indicates elapsed time. In FIG. 20, a region 1 with hatching (region of meshed square) indicates a high-load region. In the hierarchical storage controlling apparatus 10A, a certain determined region from a high-load region is determined as an expansion region as indicated by an arrow mark 2 in FIG. 20.

Further, the hierarchical storage controlling apparatus 10A considers a region obtained by joining an expansion region and a different expansion region coupled with the expansion region as one expansion region. Further, the hierarchical storage controlling apparatus 10A determines an expansion region as a movement region with regard to which data is moved to the SSD 20. In FIG. 20, a region between upper and lower broken lines is a movement region.

Further, if a movement region is determined at a certain time point, then the hierarchical storage controlling apparatus 10A retains the movement region until a high load does not appear within a fixed time period. In other words, if a high-load region disappears and does not appear for a fixed time period, then the hierarchical storage controlling apparatus 10A determines that a high load has disappeared. In FIG. 20, an arrow mark of a timeout indicates a fixed time period within which a high load does not appear.

FIG. 21 is a view depicting a different example of analysis of a workload of the hierarchical storage system 1A, and in FIG. 21, the axis of ordinate indicates an offset in an upward direction and the axis of abscissa indicates elapsed time. Further, a volume is divided into segments of a 1-GB unit and the elapsed time is indicated in a unit of one minute. In particular, in FIG. 21, each of square regions 3 with hatching indicates that one segment is placed in a high-load state for one minute. Further, reference character s indicates a number of segments expanded as an expansion region from a high-load region and, in FIG. 21, s=1.

The hierarchical storage controlling apparatus 10A joins together segments between which the distance is within s from among those segments in the high-load region to produce an n_segment. The n_segment is a movement region from which data is to be moved to the SSD 20, and the movement of data is integrally controlled. The number of segments in the n_segment is 2s+1 or more. In FIG. 21, two n_segments whose number of segments is 5 are specified.

In this manner, the hierarchical storage controlling apparatus 10A can specify an n_segment as a region whose data is to be moved to the SSD 20 such that a suitable region is selected as a peripheral region of the high-load region.

Now, a functional configuration of the hierarchical storage controlling apparatus 10A according to the application example is described. FIG. 22 is a view depicting an example of a configuration of the hierarchical storage system 1A according the application example. As depicting in FIG. 22, the hierarchical storage controlling apparatus 10A can include a hierarchy management unit 11A, the hierarchy driver 12, the SSD driver 13 and the HDD driver 14. It is to be noted that, in the following description, overlapping description of functions similar to those of the hierarchical storage controlling apparatus 10 is omitted. For example, the hierarchy driver 12, SSD driver 13 and HDD driver 14 are substantially same as those of the configuration of the hierarchical storage controlling apparatus 10 depicted in FIG. 7. Further, for the simplified illustration of the drawings, in FIG. 22, illustration of functional blocks included in the hierarchy driver 12 is omitted.

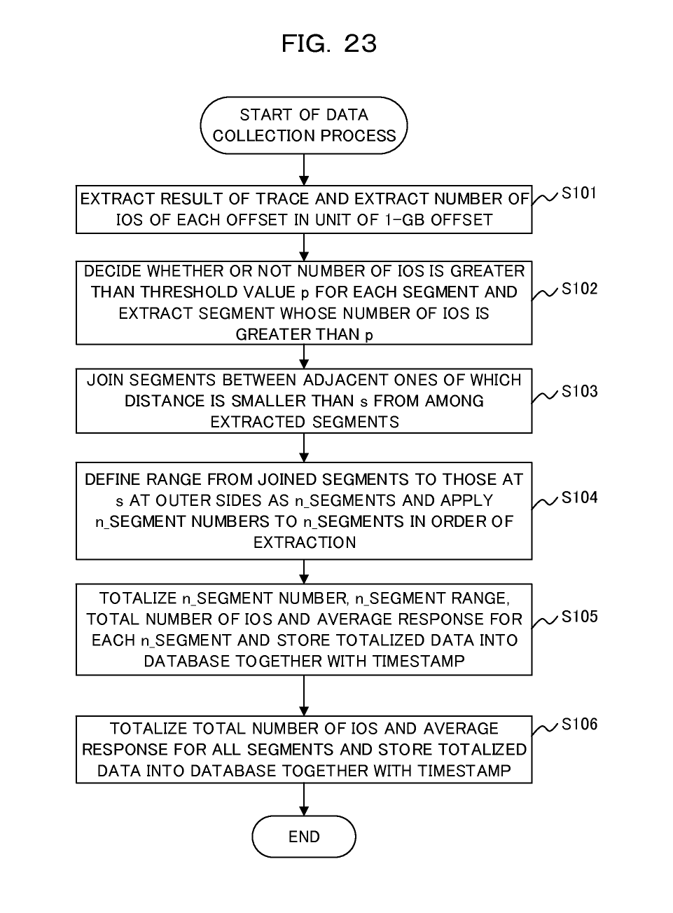

A function and operation principally of the hierarchy management unit 11A from within the hierarchical storage controlling apparatus 10A depicted in FIG. 22 are described below in accordance with a flow chart with reference to FIGS. 23 to 28.

The hierarchy management unit 11A determines an n_segment with regard to which data is moved to the SSD 20 based on information of an IO traced relating to the HDD 30, and issues an instruction for movement of data of the determined n_segment to the hierarchy driver 12. As depicted in FIG. 22, the hierarchy management unit 11A includes a data collection unit 15a, a database 15b, a workload analysis unit 15c, a movement instruction unit 15d and a division number decision unit 11e. It is to be noted that the division number decision unit 11e has a configuration substantially same as that of the hierarchical storage controlling apparatus 10 depicted in FIG. 7.

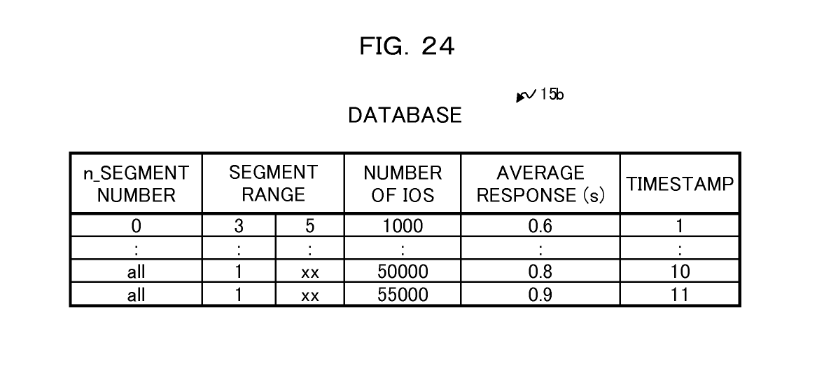

First, a processing procedure of the data collection unit 15a is described. FIG. 23 is a flow chart illustrating an example of operation of a data collection process by the data collection unit 15a according to the application example, and FIG. 24 is a view depicting an example of the database 15b depicted in FIG. 22. It is to be noted that the data collection unit 15a is started up taking, as a condition, that the blktrace command is executed for 60 seconds and then ends.

As depicted in FIG. 23, the data collection unit 15a extracts a trace result obtained by execution of the blktrace command and extracts the number of IOs of each segment in a 1-GB offset unit, namely, in a segment unit (step S101).

Then, the data collection unit 15a decides whether or not the number of IOs is greater than a threshold value p for each segment and then performs extraction of a segment whose number of IOs is greater than the threshold value p (step S102). The segment whose number of IOs is greater than the threshold value p is a high-load region.

Then, the data collection unit 15a joins together segments between which the adjacent distance is within s from among the extracted segments (step S103). Then, the data collection unit 15a defines the segments jointed together and segments within a region to s at the outer sides of the joined segments as n_segments and applies an n_segment number in an extraction order to the n_segments (step S104).

Then, the data collection unit 15a writes an n_segment number, a segment range, a number of IOs and an average response into the database 15b together with a timestamp for each n_segment (step S105).

Here, the database 15b stores information relating to an n_segment specified by a data collection unit 111 therein. As depicted in FIG. 24, the database 15b stores an n_segment number, a segment range, a number of IOs, an average response and a timestamp in an associated relationship with each other for each n_segment. For example, in an n_segment whose n_segment number is “1”, the offset of a top segment, offset of a final segment, average response, number of IOs and timestamp are “3”, “5”, “0.6” (seconds), “1000” and “1”, respectively.

Returning back to the description of FIG. 23, similarly to the data collection unit 11a depicted in FIG. 7, the data collection unit 15a totalizes a total number of IOs and average responses taking all segments as targets and stores the totalized data into the database 15b together with a timestamp (step S106). It is to be noted that the information stored in the database 15b at step S106 corresponds to an entry of the n_segment number “all” in FIG. 24.

The processing of the data collection unit 15a ends therewith.

In this manner, the data collection unit 15a can join together segments between which the adjacent distance is within s from among high-load segments to extract an n_segment, and consequently, a region in the proximity of the high-load segments is suitably selected.

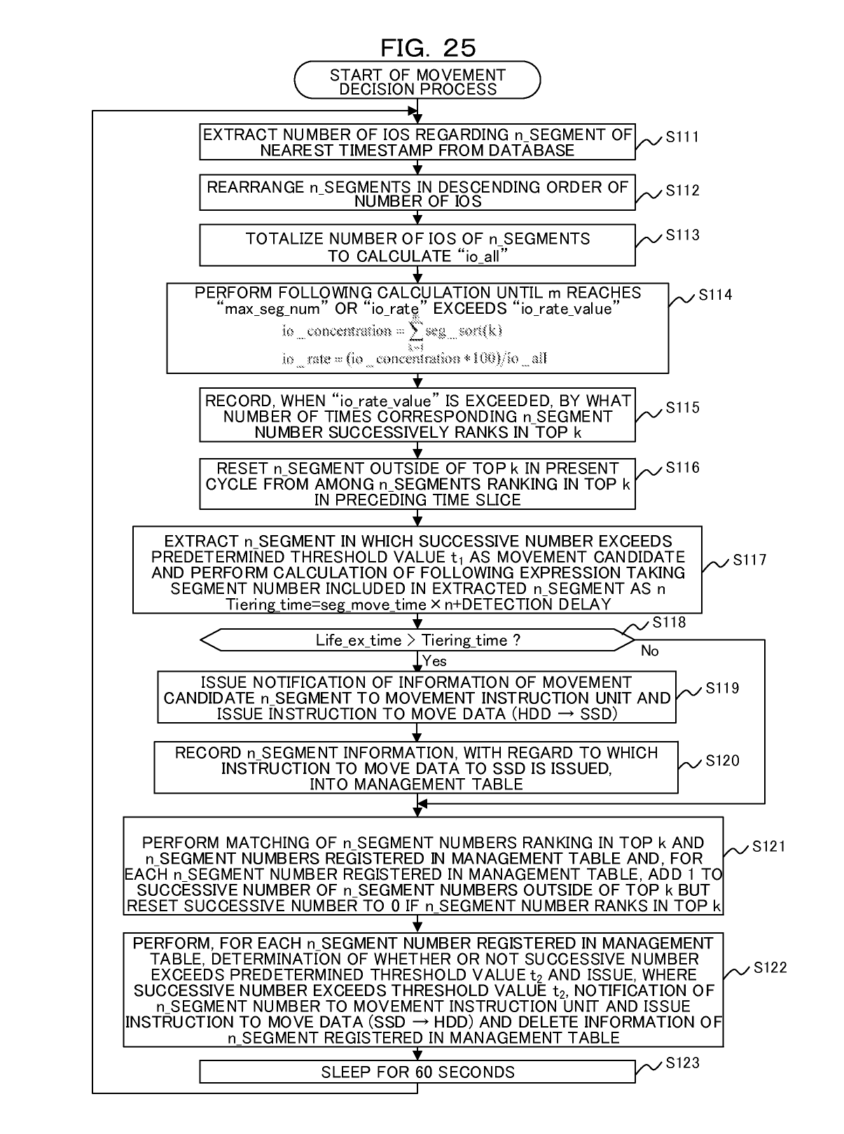

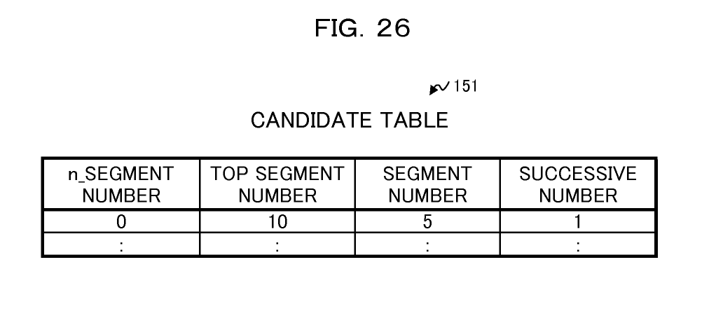

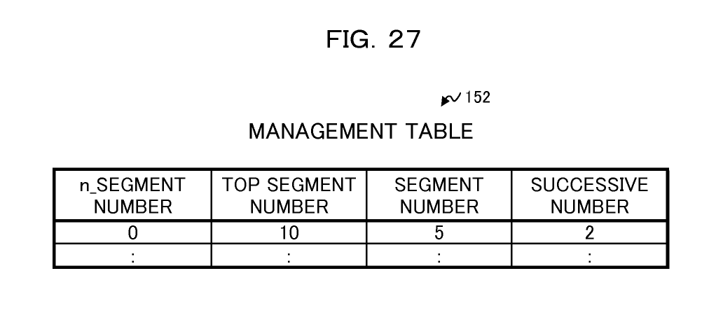

Now, a processing procedure of the workload analysis unit 15c is described. FIG. 25 is a flow chart illustrating an example of operation of a movement decision process by the workload analysis unit 15c according to the example of application. FIGS. 26 and 27 are views illustrating an example of a candidate table 151 and a management table 152 depicted in FIG. 22, respectively.

As depicted in FIG. 25, the workload analysis unit 15c extracts a number of IOs relating to an n_segment having the nearest timestamp from the database 15b (step S111), and rearranges the n_segments in descending order of the number of IOs (step S112).

Then, the workload analysis unit 15c totalizes the numbers of IOs of the n_segments to calculate io_all (step S113). Then, the workload analysis unit 15c performs calculation of the following expression (1) until m reaches max_seg_num or io_rate exceeds io_rate_value (step S114).

$$[ Expression 1 ]$$

$${io}_{—} concentration = {\sum }_{k = 1}^{m} {seg}_{—} sort ( k ) \\ {io}_{—} rate = ( {io}_{—} concentration \text{*} 100 ) \text{/} {io}_{—} all \qquad ( 1 )$$

Here, max_seg_num is the number of n_segments with regard to which movement of data to the SSD 20 is performed at the same time. Further, seg_sort (k) is the number of IOs of the n_segment to which the number of accesses is kth great. io_concentration indicates a sum total of numbers of IOs of k top n_segments, and it is indicated that, as the io_concentration number increases, accesses are concentrated more to the k top n_segments. Further, io_all indicates a total number obtained by totalizing the number of IOs for all n_segments and io_rate indicates, by percentage, a rate with respect to the total number of the totals of the number of IOs of the k top n_segments. Accordingly, it is indicated that, as the value of io_rate increases, the concentration rate of accesses to k top n_segments increases.

io_rate_value is a threshold value for deciding whether or not k top n_segments are to be selected as candidates with regard to which data is to be moved to the SSD 20.

Then, if io_rate exceeds io_rate_value, then the workload analysis unit 15c performs processes at steps S115 to S122 described below. Then, if m reaches max_seg_num, then the processing advances to step S123. In particular, when io_rate exceeds io_rate_value, the workload analysis unit 15c records by what number of times a corresponding n_segment number successively ranks in the top k into the candidate table 151 (step S115).

Here, the candidate table 151 is a table provided in the workload analysis unit 15c and stores candidates with regard to which data is to be moved to the SSD 20 therein. As depicted in FIG. 26, the candidate table 151 stores an n_segment number, a top segment number, a number of segments and a successive number (successive occurrence count) in an associated relationship with each other for each n_segment. Here, the top segment number is an offset of the top segment of the n_segment. The number of segments is a number of segments included in the n_segment. The successive number indicates a number of times by which the n_segment is successively registered as a candidate into the candidate table 151.

Returning back to the description of FIG. 25, the workload analysis unit 15c resets the successive number of an n_segment outside the top k at the present time from among the n_segments ranking in the top k in the preceding time slice (step S116).

Then, the workload analysis unit 15c extracts an n_segment whose successive number exceeds a predetermined threshold value t₁ as a movement candidate and sets the number of segments included in the extracted n_segment to n and then calculates movement time Tiering_time of the data of the n_segment (step S117).

Here, Tiering_time=seg_move_time×n+detection delay, and seg_move_time indicates time to be used for movement of data of 1 segment from the HDD 30 to the SSD 20. Further, the detection delay is time to be used for detection of a movement candidate, and is 60 seconds of the collection interval of data here.

Then, the workload analysis unit 15c compares Tiering_time and time Life_ex_time (average life expectancy time) within which it is expected that a state of high concentration rate of IOs continues with each other (step S118). If Tiering_time is equal to or longer than Life_ex_time (No route at step S118), then the processing advances to step S121. On the other hand, if Tiering_time is shorter than Life_ex_time (Yes route at step S118), then the workload analysis unit 15c issues a notification of information of the movement candidate n_segment to the movement instruction unit 15d and issues an instruction for movement of data of the movement candidate n_segment from the HDD 30 to SSD 20 (step S119). Further, the workload analysis unit 15c records information of the n_segment with regard to which an instruction for movement of the data to the SSD 20 is issued into the management table 152 (step S120).

Here, the management table 152 is a table provided in the workload analysis unit 15c and stores the n_segment selected as a target with regard to which data is to be moved to the SSD 20. As depicted in FIG. 27, the management table 152 stores an n_segment number, a top n_segment number, a number of segments and a successive number in an associated relationship with each other for each n_segment. Here, the successive number indicates a number of times by which an n_segment is not selected successively as a candidate where k top candidates are selected.

Returning back to the description of FIG. 25, the workload analysis unit 15c performs matching of n_segment numbers ranking in the top k and n_segment numbers registered in the management table 152. Further, the management table 152 increments the successive number of the n_segment number that does not rank in the top k for each of the n_segments registered in the management table 152 but resets the successive number of the n_segment to “0” if the n_segment is ranked in the top k (step S121).

Then, the workload analysis unit 15c performs determination regarding whether or not the successive number exceeds a predetermined threshold value t₂ for each of the n_segments registered in the management table 152. If the successive number exceeds the predetermined threshold value t₂, the workload analysis unit 15c issues a notification of the n_segment number to the movement instruction unit 15d to instruct the movement instruction unit 15d to move the data from the SSD 20 to the HDD 30. Further, the workload analysis unit 15c deletes information of the n_segments registered in the management table 152 (step S122). Then, the workload analysis unit 15c sleeps for 60 seconds (step S123), and the processing advances to step S111.

In this manner, by issuing an instruction for movement of data of an n_segment upon which the concentration rate of IOs is high from the HDD 30 to the SSD 20 from the workload analysis unit 15c to the movement instruction unit 15d, the user can access data of the HDD 30 at a high speed.

As described above, the workload analysis unit 15c is an example of a specification unit for specifying a movement region obtained by connection of an expansion region obtained by joining a unit region whose inputting and outputting number totalized by the data collection unit 15a is greater than the first threshold value and another unit region that is within a predetermined distance from the unit region and other expansion regions connecting to the expansion region.

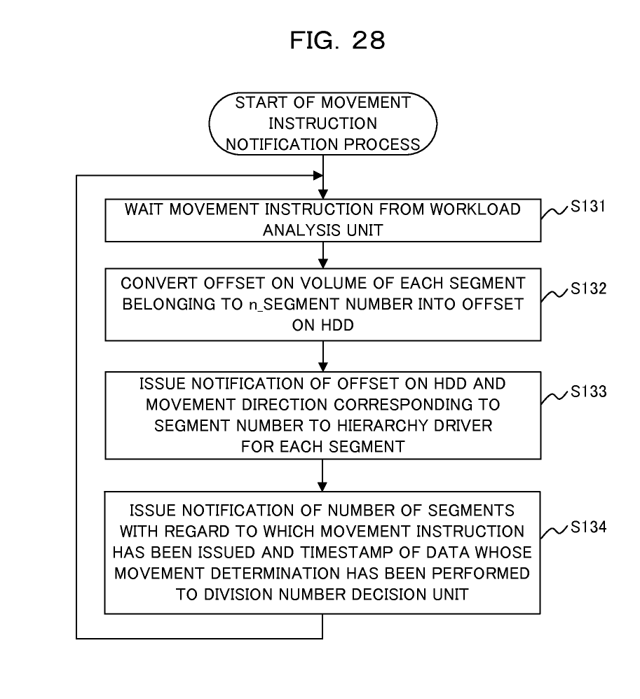

Now, a processing procedure of the movement instruction unit 15d is described. FIG. 28 is a flow chart illustrating an example of operation of a movement instruction notification process by the movement instruction unit 15d according to the application example.

As depicted in FIG. 28, the movement instruction unit 15d waits a movement instruction from the workload analysis unit 15c (step S131). If the movement instruction is received, then the movement instruction unit 15d converts an offset on a volume of each segment belonging to the n_segment number into an offset on the HDD 30 (step S132).

Then, the movement instruction unit 15d issues a notification of, for each segment, an offset on the HDD 30 corresponding to the segment number and a movement direction of the data to the hierarchy driver 12 (step S133). Here, the movement direction of the data is a direction from the HDD 30 to the SSD 20 or from the SSD 20 to the HDD 30.

Further, the movement instruction unit 15d issues a notification of the number of segments with regard to which the movement instruction is issued and a timestamp (latest timestamp) of the data for which the movement determination is performed to the division number decision unit 11e (step S134), and the processing advances to step S131.

In this manner, by converting an offset on a volume of each segment into an offset on the HDD 30 by the movement instruction unit 15d, the hierarchy driver 12 can move the data between the SSD 20 and the HDD 30.

As described above, with the hierarchical storage controlling apparatus 10A according to the present example of application, the database 15b joins together segments within the adjacent distance s from among the segments whose number of IOs exceeds the threshold value p. Then, the data collection unit 15a extracts the connected segments and a range to s at the outer sides of the connected segments as the n_segment. Further, the workload analysis unit 15c determines a target with regard to which data is to be moved from the HDD 30 to the SSD 20 using an n_segment as a unit.

At this time, the division number decision unit 11e and the division unit 12d according to the present application example can divide each of the plurality of segments belonging to the n_segment of a movement unit into a division number determined dynamically to perform hierarchical movement. For example, in the movement process for moving data stored in the movement region of the n_segment to the SSD 20, the division unit 12d divides each of the plurality of unit regions included in the movement region by a predetermined division number into a plurality of division regions. Then, the division unit 12d moves the data stored in the movement region to the SSD 20 in a unit of the division region.

Accordingly, the hierarchical storage system 1A can suitably select a region in the proximity of a high-load region and then move data from the HDD 30 to the SSD 20 in a movement unit optimum to a performance of equipment to be used or a workload, and the accessing speed to the HDD 30 can be increased.

### [2] Others

While the preferred embodiment of the present technology is described in detail, the present technology is not limited to the embodiment specifically described above, and variations and modifications can be made without departing from the scope of the present technology.

For example, while, in the embodiment, the hierarchical storage systems 1 and 1A that use the SSD 20 and the HDD 30 are described, the embodiment is not limited to this, and the present technology can be applied, for example, also to a hierarchy storage system using a cache memory and a main storage device similarly to the embodiment. In particular, the present technology can be applied not only to a hierarchical storage system of a nonvolatile storage apparatus but also to a hierarchy storage system including a volatile storage apparatus.

Further, the hierarchical storage systems 1 and 1A according to the embodiment can be applied not only to the SSD 20 and the HDD 30 but also to storage apparatus that have a speed difference therebetween. For example, the present technology can be applied also to a hierarchical storage system for which an HDD and a magnetic recording apparatus such as a tape drive that has a greater capacity but is lower in speed than an HDD are used.

Further, while, in the embodiment, the operation of the hierarchical storage controlling apparatus 10 and 10A is described taking notice of the one SSD 20 and the one HDD 30, this similarly applies also to a case in which a plurality of SSDs 20 and a plurality of HDDs 30 are provided in the hierarchical storage systems 1 and 1A.

With the embodiment, degradation of the response performance to an inputted request can be suppressed while the processing time to be used for data movement from the first embodiment to the second embodiment is reduced.

All examples and conditional language recited provided herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A storage controlling apparatus, comprising:
a processor configured to
monitor a response performance to an inputted request regarding a plurality of unit regions obtained by dividing a storage region of the first storage apparatus in a predetermined size;
divide, in a moving process for moving data stored in a unit region, which is a movement target, of the first storage apparatus to a second storage apparatus having a performance different from that of the first storage apparatus, the unit region of the movement target into a plurality of divisional regions by a predetermined division number and moves the data to the second storage apparatus in a unit of the divisional region; and
change the predetermined division number based on a first response performance during execution of the monitored moving process.

2. The storage controlling apparatus according to claim 1, wherein the processor is configured to change the predetermined division number based on the first response performance and a second response performance before execution of the moving process.

3. The storage controlling apparatus according to claim 2, wherein the predetermined division number is calculated based on the second response performance before execution of the moving process.

4. The storage controlling apparatus according to claim 1, wherein the processor is configured to:
compare the first response performance and the second response performance with each other; and
increase the predetermined division number when it is determined that the first response performance is lower than the second response performance, but decreases the predetermined division number when it is determined that the first response performance is higher than the second response performance.

5. The storage controlling apparatus according to claim 4, wherein the processor is configured to:
acquire a plurality of first response performances monitored at a plurality of time points during execution of the moving process;
compare the second response performance and an average value of the plurality of response performances; and
increase or decrease the predetermined division number in response to a result of the determination of whether or not the average value is lower than the second response performance.

6. The storage controlling apparatus according to claim 1, wherein the processor is further configured to:
totalize the number of inputs and outputs for each unit region regarding the plurality of unit regions;
specify a movement region configured from an expansion region obtained by joining a unit region whose totalized number of inputs and outputs is greater than a first threshold value and another unit region positioned within a predetermined distance from the unit region and a different expansion region coupled with the expansion region;
divide, in a moving process for moving data stored in the movement region to the second storage apparatus, each of a plurality of unit regions included in the movement region into a plurality of divisional regions by the predetermined division number; and
move the data stored in the movement region to the second storage apparatus in a unit of the divisional region.

7. A computer-readable recording medium having stored therein a control program for causing a computer to execute a process for controlling a first storage apparatus and a second storage apparatus, the process comprising:
monitoring a response performance to an inputted request regarding a plurality of unit regions obtained by dividing a storage region of the first storage apparatus in a predetermined size;
performing a moving process for moving data stored in a unit region, which is a movement target, of the first storage apparatus to a second storage apparatus having a performance different from that of the first storage apparatus;
dividing, in the moving process, the unit region of the movement target into a plurality of divisional regions by a predetermined division number;
moving the data to the second storage apparatus in a unit of the divisional region; and
changing the predetermined division number based on the first response performance during execution of the monitored moving process by the monitoring.

8. The computer-readable recording medium according to claim 7, wherein the process comprises changing, in the changing, the predetermined division number based on the first response performance and a second response performance before execution of the moving process.

9. The computer-readable recording medium according to claim 8, wherein the predetermined division number is calculated based on the second response performance before execution of the moving process.

10. The computer-readable recording medium according to claim 7, wherein, in the changing, the process comprises:
comparing, in the process for changing, the first response performance and the second response performance with each other; and
increasing the predetermined division number when it is determined that the first response performance is lower than the second response performance, but decreasing the predetermined division number when it is determined that the first response performance is higher than the second response performance.

11. The computer-readable recording medium according to claim 10, wherein in the changing, the process comprises:
acquiring, in the process for changing, a plurality of first response performances monitored at a plurality of time points during execution of the moving process by the monitoring;
comparing the second response performance and an average value of the plurality of response performances with each other; and
increasing or decreasing the predetermined division number in response to a result of the comparison of whether or not the average value is lower than the second response performance.

12. The computer-readable recording medium according to claim 7, wherein the process further comprises:
totalizing the number of inputs and outputs for each unit region regarding the plurality of unit regions;
specifying a movement region configured from an expansion region obtained by joining a unit region whose totalized number of inputs and outputs is greater than a first threshold value and another unit region positioned within a predetermined distance from the unit region and a different expansion region coupled with the expansion region;
dividing, in a moving process for moving data stored in the movement region to the second storage apparatus, each of a plurality of unit regions included in the movement region into a plurality of divisional regions with the predetermined division number; and
moving the data stored in the movement region to the second storage apparatus in a unit of the divisional region.

13. A controlling method for a storage controlling apparatus that performs control of a first storage apparatus and a second storage apparatus, the method comprising:
monitoring a response performance to an inputted request regarding a plurality of unit regions obtained by dividing a storage region of the first storage apparatus in a predetermined size;
performing a moving process for moving data stored in a unit region, which is a movement target, of the first storage apparatus to a second storage apparatus having a performance different from that of the first storage apparatus;
dividing, in the moving process, the unit region of the movement target into a plurality of divisional regions by a predetermined division number;
moving the data to the second storage apparatus in a unit of the divisional region; and
changing the predetermined division number based on the first response performance during execution of the monitored moving process by the monitoring.

14. The controlling method according to claim 13, wherein the method comprises changing, in the changing, the predetermined division number based on the first response performance and a second response performance before execution of the moving process.

15. The controlling method according to claim 14, wherein the predetermined division number is calculated based on the second response performance before execution of the moving process.

16. The controlling method according to claim 13, wherein, in the changing, the method comprises:
comparing, in the process for changing, the first response performance and the second response performance with each other; and
increasing the predetermined division number when it is determined that the first response performance is lower than the second response performance, but decreasing the predetermined division number when it is determined that the first response performance is higher than the second response performance.

17. The controlling method according to claim 16, wherein, in the changing, the method comprises:
acquiring, in the process for changing, a plurality of first response performances monitored at a plurality of time points during execution of the moving process by the monitoring;
comparing the second response performance and an average value of the plurality of response performances with each other; and
increasing or decreasing the predetermined division number in response to a result of the comparison of whether or not the average value is lower than the second response performance.

18. The controlling method according to claim 13, wherein the method further comprises:
totalizing the number of inputs and outputs for each unit region regarding the plurality of unit regions;
specifying a movement region configured from an expansion region obtained by joining a unit region whose totalized number of inputs and outputs is greater than a first threshold value and another unit region positioned within a predetermined distance from the unit region and a different expansion region coupled with the expansion region;
dividing, in a moving process for moving data stored in the movement region to the second storage apparatus, each of a plurality of unit regions included in the movement region into a plurality of divisional regions with the predetermined division number; and
moving the data stored in the movement region to the second storage apparatus in a unit of the divisional region.
